(19) United States
(12) Patent Application Publication
(10) Pub. No.: US 2026/0099533 A1
(43) Pub. Date: Apr. 9, 2026

(54) Raw Content Storage and Analysis Using Topic Maps

(71) Applicant: Oracle International Corporation, Redwood Shores, CA (US)

(72) Inventor: Jean-Francois Verrier, Rognes (FR)

(73) Assignee: Oracle International Corporation, Redwood Shores, CA (US)

(21) Appl. No.: 19/398,208

(22) Filed: Nov. 24, 2025

Related U.S. Application Data
(63) Continuation-in-part of application No. 18/891,244, filed on Sep. 20, 2024.
(60) Provisional application No. 63/688,955, filed on Aug. 30, 2024.

(51) Int. Cl. G06F 16/358; G06F 16/3329; G06F 16/3332; G06F 40/103; G06N 3/0475

(52) U.S. Cl. CPC G06F 16/358; G06F 16/3329; G06F 16/3334; G06F 40/103; G06N 3/0475

(57) ABSTRACT

Techniques for receiving, storing, analyzing, and utilizing raw content are disclosed. The system receives raw text from a user, including a first tag and second tags. The system identifies and removes formatting attributes in the raw text, including whitespace characters, to generate a normalized input. The system stores the normalized input in target dataset(s) and parses the normalized input for the first tag and the second tags. In this case, the first tag corresponds to one or more topics, and the second tags represent a computing system associated with corresponding portions of the normalized input. The system analyses the first tag and the second tags to identify the topics. The system generates one or more topic maps for the target dataset(s) based on the first tag and the one or more second tags. The topic map(s) include one or more references to content items within the target dataset(s).

### INCORPORATION BY REFERENCE; DISCLAIMER

Each of the following applications are hereby incorporated by reference: application Ser. No. 18/891,244 filed on Sep. 20, 2024; application No. 63/688,955 filed on Aug. 30, 2024. The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to utilizing generative artificial intelligence (AI) agents and retrieval-augmented generation (RAG) for storing and analyzing raw content.

### BACKGROUND

Generative artificial intelligence (GenAI) agents are conversational systems powered by large language models (LLMs) trained on vast amounts of text data. These models, sometimes based on transformer architectures, use self-attention mechanisms and deep neural networks to generate human-like responses to user inputs. They operate by predicting the most likely sequence of tokens given a prompt, leveraging patterns learned from their training data. While powerful, these systems often struggle with up-to-date information, factual accuracy, and consistency across interactions due to their reliance on static, pre-trained knowledge. Retrieval-augmented generation (RAG) is an advanced natural language processing (NLP) technique that combines information retrieval with text generation to produce more accurate and contextually relevant outputs. This approach enhances LLMs by incorporating external knowledge sources during the generation process.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

One or more embodiments of the present disclosure are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example multi-tenant provider network environment in which techniques for topic maps for constrained RAG are implemented according to an embodiment of the present disclosure;

FIG. 2 is a flowchart of a process for topic map generation from online documentation according to an embodiment of the disclosure;

FIG. 3 is a flowchart of a process performed by a generative artificial intelligence (GenAI) agent and a large language model (LLM) in processing a query received from a topic scope AI agent according to an embodiment of the present disclosure;

FIG. 4A is a flowchart of a first process for topics maps for constrained RAG according to an embodiment of the present disclosure;

FIG. 4B is a flowchart of a second process for topics maps for constrained RAG according to an embodiment of the present disclosure;

FIG. 5 illustrates an example structure of an LLM prompt that is transmitted from a topic scope AI agent to a GenAI agent according to an embodiment of the present disclosure;

FIG. 6 illustrates an example LLM prompt that imposes a strict constraint level on a GenAI agent according to an embodiment of the present disclosure;

FIG. 7 illustrates an example LLM prompt that substantially or mostly constrains a GenAI model to provided content according to an embodiment of the present disclosure;

FIG. 8 illustrates a graphical user interface (GUI) designed to provide users with an intuitive and interactive way to navigate online documentation while also leveraging the power of GenAI according to an embodiment of the present disclosure;

FIG. 9 illustrates an example LLM prompt template that uses content item summaries instead of content item references according to an embodiment of the present disclosure;

FIG. 10 illustrates an example data structure format for representing topic maps in a topic vault according to an embodiment of the present disclosure;

FIG. 11 illustrates an example prompt template that incorporates content item relevance scores according to an embodiment of the present disclosure;

FIGS. 12A-12B illustrate an example method for input normalization and topic map generation based on tags according to an embodiment of the present disclosure;

FIGS. 13A-13B illustrate an example method for topic map retrieval and hypertext markup language (HTML) generation based on tags according to an embodiment of the present disclosure;

FIG. 14 illustrates an example of raw text according to an embodiment of the present disclosure;

FIG. 15 illustrates an example of normalized text according to an embodiment of the present disclosure;

FIG. 16 illustrates an example of HTML generation text according to an embodiment of the present disclosure;

FIG. 17 illustrates a machine learning (ML) engine according to an embodiment of the present disclosure; and

FIG. 18 illustrates the operation of an ML engine according to an embodiment of the present disclosure.

### DETAILED DESCRIPTION

In the following detailed description, for the purposes of explanation, numerous specific details are set forth to aid understanding of one or more embodiments of the present disclosure. In some instances, an embodiment of the present disclosure may be practiced without one or more of these specific details. In some cases, a described feature of one embodiment of the present disclosure is also a feature of one or more other embodiments of the present disclosure even though the feature is not expressly described with respect to the one or more other embodiments. In some embodiments, well-known structures and devices are shown in the figures in block diagram form to avoid unnecessarily obscuring the embodiment.
1. INTRODUCTION
2. GENERAL OVERVIEW
3. MULTI-TENANT PROVIDER NETWORK ENVIRONMENT
   3.1 TOPIC SCOPE AI AGENT
   3.2 TOPIC FORGE
   3.3 TOPIC VAULT
   3.4 TOPIC MAPS
   3.5 GENERATIVE AI AGENT
4. EXAMPLE METHODS FOR TOPICS MAPS FOR CONSTRAINED RETRIEVAL AUGMENTED GENERATION
5. GUI EXAMPLE
6. TOPIC MAPS WITH CONTENT ITEM SUMMARIES
7. CONTENT ITEM RELEVANCE RANKING/SCORING
8. EXTENSIONS AND ALTERNATIVES
9. METHOD FOR INPUT NORMALIZATION AND TOPIC MAP GENERATION BASED ON TAGS
10. METHOD FOR TOPIC MAP RETRIEVAL AND HTML GENERATION BASED ON TAGS
11. RAW TEXT INPUT AND RETRIEVAL EXAMPLE
12. MACHINE LEARNING ARCHITECTURE
13. GENERATIVE MODELS
14. PRACTICAL APPLICATIONS, ADVANTAGES, AND IMPROVEMENTS
15. TERMINOLOGY

### 1. Introduction

Users are increasingly opting to obtain information by submitting natural language queries to GenAI systems rather than consulting conventional published content sources, such as documentation, manuals, or online articles. This shift is driven by the ability of GenAI systems to provide contextually relevant, synthesized responses tailored to a user's specific question, thereby reducing the time and cognitive effort required to locate and interpret information dispersed across multiple documents. As a result, users rely less on traditional static content repositories and more on dynamically generated explanations produced on demand, creating a growing preference for interactive query-driven information retrieval over manual reading of existing materials.

Despite these advantages, GenAI may exhibit a lack of precision when underlying data is incomplete, ambiguous, or outside the model's training scope. In such cases, the system may generate plausible sounding but inaccurate statements, conflate similar concepts, or omit critical qualifying details. This variability requires users to apply judgment and, in some contexts, to validate AI-generated outputs against authoritative references to ensure correctness and reliability.

The challenge of incorporating new information is rooted in the static nature of an LLM's pre-trained knowledge. Once trained, these models cannot easily assimilate new data without undergoing resource-intensive fine-tuning or retraining processes that typically occur infrequently due to computational costs. This results in a significant lag between the emergence of new information and its integration into the model's knowledge base.

Lastly, the resource intensiveness of building or fine-tuning LLMs presents a substantial barrier to entry. The computational requirements for training large-scale models, including high-performance hardware, extensive datasets, and significant energy consumption, make it impractical for many organizations or individuals to develop custom solutions or adapt existing models to specific domains or up-to-date information.

These issues collectively point to the limitations of relying solely on pre-trained LLMs for agent applications, especially in contexts requiring consistency, factual accuracy, and up-to-date information.

### 2. General Overview

One or more embodiments receive raw text from a user including a first tag and second tags. The system identifies and removes formatting attributes in the raw text, including whitespace characters, to generate a normalized input. The system stores the normalized input in target dataset(s) and parses the normalized input for the first tag and the second tags. In this case, the first tag corresponds to one or more topics, and the second tags represent a computing system associated with corresponding portions of the normalized input. The system analyzes the first tag and the second tags to identify the topics. For the topics, the system generates a topic description based on the first tag, the second tags, and the content items in the target dataset(s) relevant to the topic. The system also identifies a set of references to the first tag, the second tags, and the content items in the target dataset(s) relevant to the topic. Lastly, the system creates the topic map, including the topic, the topic description, and the set of references. The topic map(s) include one or more references to content items within the target dataset(s).

One or more embodiments described in this Specification and/or recited in the claims may not be included in the General Overview section.

### 3. Multi-Tenant Provider Network Environment

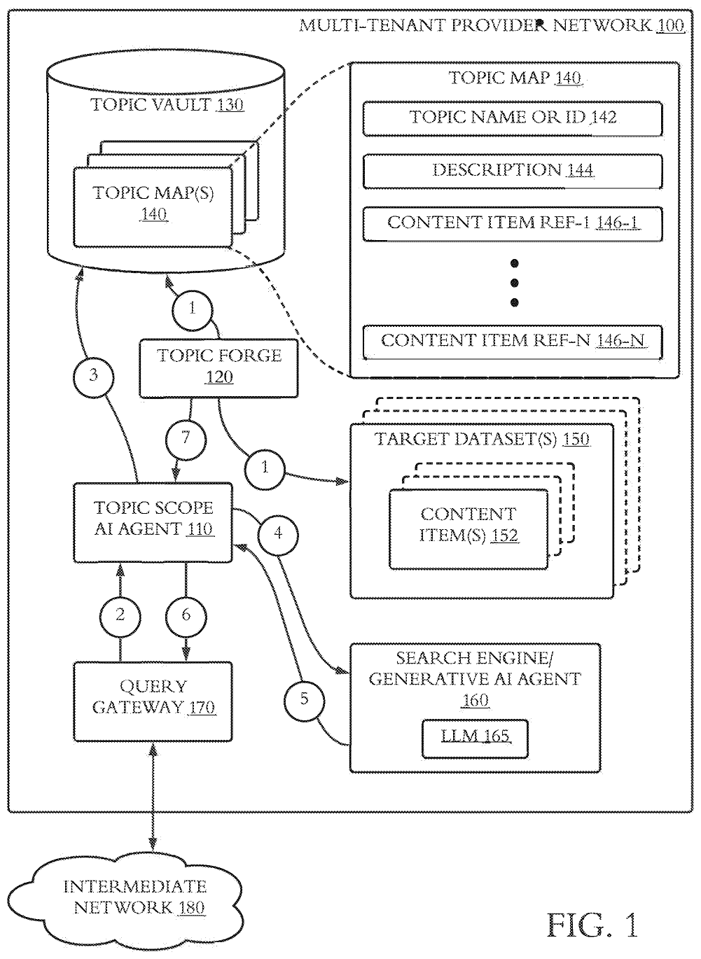

In an embodiment, the techniques for topic maps for constrained retrieval augmented generation are implemented in a multi-tenant provider network environment. FIG. 1 illustrates an example multi-tenant provider network environment in which the techniques are implemented, according to an embodiment of the present disclosure.

In an embodiment, a multi-tenant provider network 100 incorporating a topic scope AI agent 110 configured to perform the techniques for topic maps for constrained retrieval augmented generation is structured as a scalable cloud-based system designed to serve multiple clients (tenants) simultaneously. The network 100 uses distributed computing resources, load balancing, and data partitioning to ensure efficient performance and data isolation between tenants. The topic scope AI agent 110 interfaces with various microservices and data stores to execute the query processing and response generation workflow.

In an embodiment, the provider network 100 utilizes a containerized architecture, using a container orchestration service for orchestration to deploy and manage the topic scope AI agent 110 and its associated services. A distributed database system referred to as topic vault 130 stores the topic maps 140 and content item references 146, with data sharding implemented to segregate information by tenant. The network 100 employs a query gateway 170 to handle incoming queries and to implement authentication, rate limiting, and request routing. The gateway 170 directs queries to the appropriate instance of the topic scope AI agent 110 based on tenant identification and load distribution.

The query gateway 170 serves as an entry point for incoming queries in the multi-tenant provider network 100, acting as an intermediary between external clients and the internal components of the system, particularly the topic scope AI agent 110. The gateway 170 is designed to handle high-volume, concurrent requests from diverse sources, ensuring efficient and secure routing of queries to the appropriate processing components. Furthermore, the query gateway 170 serves as an entry point for incoming additions or changes to target dataset(s) 150 or content item(s) 152 within the target dataset(s) 150 in the multi-tenant provider network 100. The incoming additions or changes can be received and modified by the query gateway 170 and/or topic forge 120, as described below.

The query gateway 170 is connected to an intermediate network 180 that represents a broader network infrastructure that bridges external client networks and the provider network 100. For example, the intermediate network 180 could be implemented as a content delivery network (CDN), a virtual private network (VPN), or a specialized edge network designed to handle incoming traffic from various geographical locations and network topologies. Furthermore, the intermediate network 180 may be configured to facilitate communication between a plurality of users, tenants, or similar entities and the network 100. In one embodiment, the intermediate network 180 operates as a logically separate layer through which all tenant-directed traffic is received, processed, and routed. The intermediate network 180 may further provide shared services, such as request validation, load balancing, protocol translation, or security inspection, that are applied uniformly across incoming traffic while remaining agnostic to the underlying physical infrastructure.

Upon receiving the query from the intermediate network 180, the query gateway 170 performs any of the following functions: loading balancing, authentication and authorization, rate limiting, request validation, tenant identification, request routing, protocol translation, logging and monitoring, caching, DDOS protection, or any other suitable query gateway function. In an embodiment, once the query gateway 170 has processed the incoming first query, it forwards this query (or a transformed version of it) to the appropriate instance of the topic scope AI agent 110. For example, this forwarding could be accomplished via internal, high-speed network connections within the provider network 100, ensuring minimal latency and maximum security.

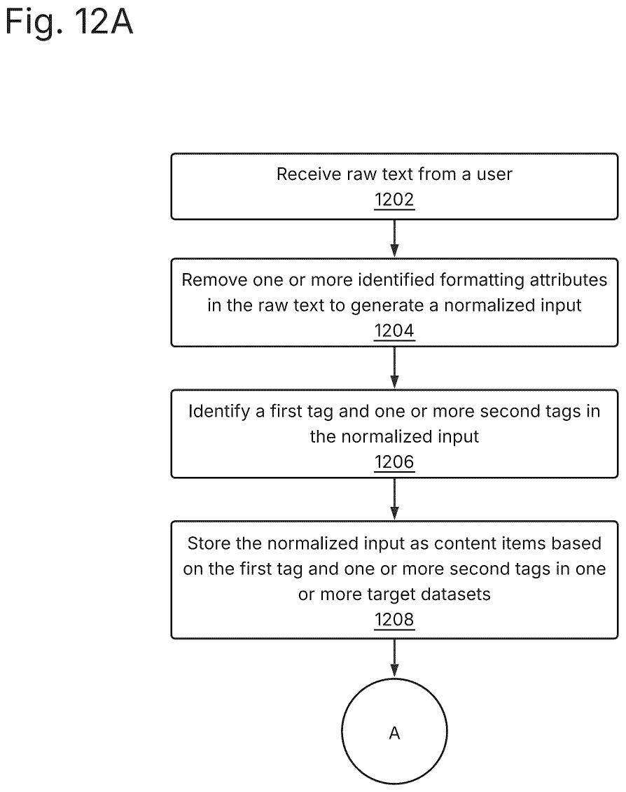

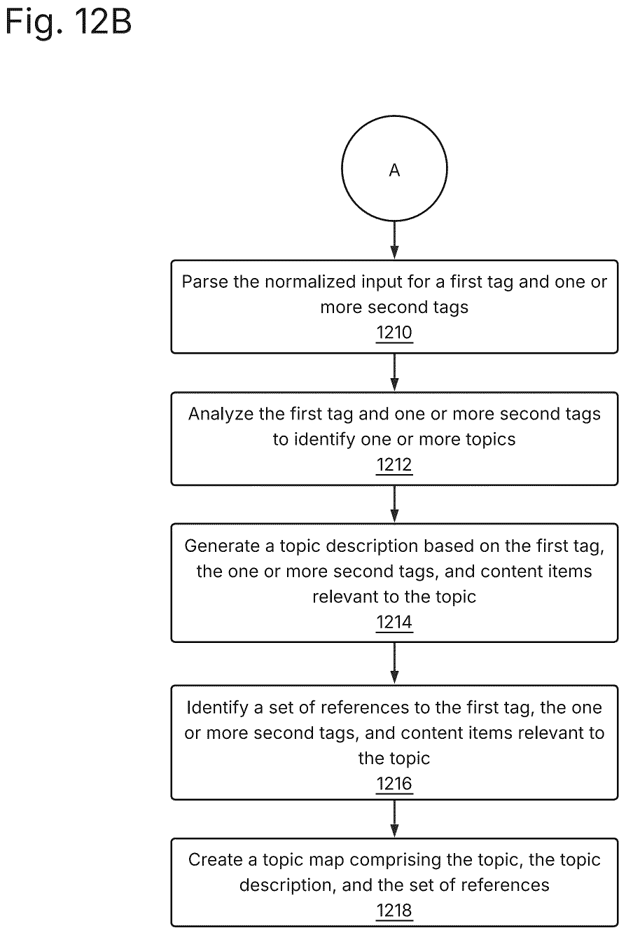

In one or more embodiments, the query gateway 170 is configured to detect and remove formatting attributes embedded within the raw text to generate a normalized input. The query gateway 170 may analyze the raw text submissions to distinguish nonfunctional formatting attributes and strip or normalize the attributes. Examples of formatting attribute processing are described with respect to FIGS. 12-16 below. Furthermore, the query gateway 170 is configured to receive raw text submissions that include one or more tags. The query gateway 170 may parse the raw text or normalized input to detect the embedded tags, which may be expressed as keywords, delimiters, annotations, or other syntactic markers. The query gateway 170 associates the detected tags with corresponding identifiers in the target dataset(s) 150. The query gateway 170 provides further instructions on routing the normalized input to appropriate locations within the target dataset(s) 150 and to topic forge 120 for the generation of topic maps.

In an embodiment, the topic scope AI agent 110 is implemented as an application programming interface (API) service, facilitating scaling and fault tolerance. Topic vault 130 is a high-performance vector database for efficient similarity search when identifying relevant topic maps. The large language model (LLM) 165 is served using a high-performance serving system for machine learning models, optimized for low-latency inference. A distributed cache could be employed in network 100 to store frequently accessed topic maps 140 and query results, improving response times for common queries.

In an embodiment, the network 100 incorporates a dedicated service, referred to as topic forge 120 in FIG. 1, for topic map 140 generation and updates. The topic forge 120 processes incoming datasets 150 using a distributed computing framework for scalable data processing. Topic forge 120 periodically updates the topic maps 140 based on new data or feedback, ensuring the topic vault 130 remains current. A separate analytics service (not depicted in FIG. 1) is used in network 100 track usage patterns, performance metrics, and query statistics, providing insights for system optimization and billing purposes. Additionally, or alternatively, the topic forge 120 generates and/or updates the topic maps 140 based on the one or more tags detected in the raw input submission or normalized input. The one or more tags may include references to existing topics or define new topics within the target dataset(s) 150.

In an embodiment, to handle the multi-tenant aspect, the network 100 implements isolation mechanisms at both the application and infrastructure levels. This includes tenant-specific encryption keys, virtual private clouds, and strict access controls. A central identity and access management system governs permissions across components of the network 100. The network 100 is designed with high availability in mind, potentially utilizing multi-region deployment, automated failover mechanisms, and comprehensive monitoring and alerting systems to ensure reliability and performance for tenants.

### 3.1 Topic Scope AI Agent

In an embodiment, the topic scope AI agent 110 performs the techniques for topic maps for constrained retrieval augmented generation. The techniques unfold as a set of interconnected operations within the multi-tenant provider network 100. The topic scope AI agent 110, functioning as an API service, initiates its workflow upon receiving a first query through the query gateway 170. The gateway 170, having already handled authentication and rate limiting, routes the query to an appropriate instance of the topic scope AI agent 110 based on tenant identification and current load distribution.

Upon receiving the first query, the topic scope AI agent 110 generates a second query, either by using the first query directly or by refining it based on predefined rules or machine learning algorithms. The agent 110 interfaces with the topic vault 130 using its vector database capabilities to efficiently identify a subset of relevant topic maps from among the stored topic maps 140. This identification process involves semantic similarity computations between the second query and the topics represented in the topic maps.

Each identified topic map in the subset includes a topic pertinent to one or more target datasets 150 and a plurality of references to content items 146 relevant to that topic. The topic scope AI agent 110 aggregates these references, preparing them for transmission along with the second query to the LLM 165 component.

The LLM 165, optimized for low-latency inference, receives the second query and the collated content item references. The LLM 165 generates an answer scoped specifically to the information contained in or pointed to by these references. This constrained generation process produces relevant and accurate responses while minimizing hallucinations or out-of-scope information.

After generating the answer, the LLM 165 returns the results to the topic scope AI agent 110. The agent 110 receives this set of one or more results for the second query. The topic scope AI agent 110 stores these results, potentially utilizing a distributed cache for quick access to frequently requested information. This storage step can serve immediate retrieval purposes but could also feed into analytics services for system optimization and provide data for potential refinement of topic maps by the topic forge 120.

### 3.2 Topic Forge

In an embodiment, the topic forge 120 is a dedicated service within the multi-tenant provider network 100 that generates and maintains the topic maps 140. Operating on a distributed computing framework, the topic forge 120 processes incoming datasets 150 that may represent one or more target datasets.

In an embodiment, the topic forge 120 employs natural language processing (NLP) and machine learning techniques to analyze the content of the datasets 150. Topic forge 120 can utilize algorithms such as Latent Dirichlet Allocation (LDA), Non-negative Matrix Factorization (NMF), or more advanced transformer-based models to identify prevalent topics within the datasets 150. For each identified topic, the topic forge 120 would generate a topic map structure that includes the topic name, a brief description, and a plurality of references to content items 152 within the datasets 150 that are relevant to that topic.

In an embodiment, the topic forge 120 handles the multi-dataset aspect. The topic forge 120 processes and integrates information from multiple datasets 150, potentially employing techniques like cross-dataset topic modeling or federated learning to create topic maps 140 that span multiple data sources. The topic forge 120 generates comprehensive topic maps that can later be used by the topic scope AI agent 110 to provide multi-source responses to queries.

In an embodiment, for data isolation in the multi-tenant environment, the topic forge 120 implements tenant-specific processing pipelines. Topic forge 120 uses the provider network 100's identity and access management system to ensure that datasets and resulting topic maps are correctly associated with and accessible to the appropriate tenants.

In an embodiment, the topic forge 120 operates both in batch mode for initial topic map generation and in an incremental update mode. In the latter, the topic forge 120 periodically or reactively processes new data additions to the datasets 150, updating existing topic maps or generating new ones as necessary. This ensures that the topic maps 140 stored in the topic vault 130 remain current and reflective of the latest information in the datasets.

In an embodiment, the topic forge 120 implements a feedback loop mechanism. The topic force 120 analyzes usage patterns and performance metrics of the topic scope AI agent 110 to refine and optimize the topic maps over time. The topic force 120 adjusts the granularity of topics, refining the relevance of content item references, or restructures topic hierarchies based on observed query patterns.

In an embodiment, the topic forge 120 is designed to handle large-scale data processing efficiently. The topic force 120 employs techniques like parallel processing, data sharding, and distributed computing to manage the potentially massive datasets 150 across multiple tenants. The resulting topic maps are optimized for quick retrieval and efficient similarity searching, aligning with the needs of the topic scope AI agent 110 in rapidly identifying relevant topic maps for incoming queries.

By generating and maintaining high-quality, up-to-date topic maps, the topic forge 120 enables constrained retrieval augmented generation, ensuring that the topic scope AI agent 110 has access to relevant, structured knowledge for generating accurate and contextually appropriate responses to queries.

In an embodiment, the one or more target datasets 150 are diverse, large-scale collections of information that serve as the primary sources for generating topic maps and, ultimately, for answering queries through the topic scope AI agent 110. In the context of a multi-tenant provider network 100, the target dataset(s) 150 are structured to support efficient storage, retrieval, and processing while maintaining strict data isolation between tenants. Each dataset within the collection is implemented as a distributed database or a cloud-based data lake, capable of storing massive amounts of both structured and unstructured data. These datasets utilize large-scale data storage technology for distributed storage and processing or cloud-native solutions for scalable object storage.

The content items 152 within these datasets represent individual pieces of information. These pieces vary widely in nature and format, including but not limited to, the following: text documents (e.g., articles, reports, research papers), structured data (e.g., CSV files, JSON objects, database records), semi-structured data (e.g., XML files, log files), multimedia content (e.g., images, audio files, video files with associated metadata), web pages or web-scraped content, social media posts or user-generated content. time-series data from IoT devices or sensors, code repositories, or technical documentation

In an embodiment, content item(s) 152 is associated with metadata, such as creation date, last modified date, author information, and tenant identifier. This metadata is used to maintain data lineage, enabling efficient search and retrieval as well as ensuring proper data governance in the multi-tenant environment.

In an embodiment, the target dataset(s) 150 are organized and indexed in a way that facilitates rapid content analysis and topic extraction by the topic forge 120. This involves implementing indexing structures, like inverted indices for text content, or utilizing specialized databases optimized for specific content types (e.g., graph databases for highly interconnected data). The target dataset(s) 150 can utilize the contents of the one or more tags to determine a particular partition, shard, table, object path, or other logical storage construct defined within the target dataset(s) 150. The network 100 may consult a mapping registry or metadata catalog that associates the one or more tags with corresponding storage locations. The one or more tags may be utilized as semantic indicators, either in conjunction with or separate from the content items 152, of where relevant data resides within the target dataset(s) 150.

In an embodiment, access to the target dataset(s) 150 is provided by a unified data access layer. This layer abstracts the complexities of accessing and querying heterogeneous data sources, presenting a consistent interface to other components like the topic forge 120, the query gateway 170, the intermediate network 180, and/or other components not depicted in FIG. 1. Direct access to the target dataset(s) 150 can be provided through the unified data access layer. Alternatively, indirect access can be provided to the target dataset(s) 150 through other components depicted in FIG. 1.

In an embodiment, to handle the scale and diversity of the content items 152, data partitioning and sharding strategies are employed. For instance, content items 152 are distributed across multiple nodes based on tenant IDs, content types, or other relevant criteria. This allows for parallel processing and improved query performance.

In an embodiment, the target dataset(s) 150 support versioning and change tracking of content items 152. This maintains the accuracy of derived topic maps and ensures that the topic scope AI agent 110 always works with the most up-to-date information. A change data capture (CDC) mechanism is implemented to track modifications to content items and trigger updates to relevant topic maps.

In an embodiment, security and access control is employed for the target dataset(s) 150. Each content item 152 is associated with specific access permissions, ensuring that tenants can only access their own data. Encryption at rest and in transit is implemented to protect sensitive information.

Several approaches could be used to automatically generate the set of topic maps 140 from the one or more target datasets 150.

Unsupervised topic modeling is one possible approach. A statistical model, such as Latent Dirichlet (LDA), could be applied to the target dataset(s) 150 to discover latent topics. Each discovered topic could form the basis of a topic map, with the most relevant documents or content items for that topic included as references. Additionally, or alternatively, Non-negative Matrix Factorization (NMF) can be used to extract topics from a document-term matrix. The resulting topics and their associated documents could be used to construct topic maps.

Hierarchical clustering is another possible approach. A hierarchical clustering algorithm (e.g., agglomerative clustering) can be applied to group similar documents or content items. Each cluster could represent a topic, with the centroid or most representative items forming the topic description and the cluster members becoming the references.

Keyword extraction and graph-based methods is another possible approach. An unsupervised technique based on a graph-based ranking algorithm or frequency and co-occurrence statistics can be used to extract important keywords and phrases from the dataset. A graph can be constructed where nodes are keywords/phrases and edges represent co-occurrence or semantic similarity. Community detection algorithms can be applied to identify clusters of related terms that could form the basis for topic maps.

Named Entity Recognition (NER) and knowledge graph construction is another possible approach. NER can be applied to the target dataset(s) 150 to identify key entities (e.g., people, organizations, locations). A knowledge graph can be constructed based on entity co-occurrences and relationships. Graph clustering or community detection can be used to identify subgraphs that could serve as topics for the topic maps.

A transformer-based approach is another possible approach. Pre-trained language models like BERT or GPT can be used to generate embeddings for documents or sections of the dataset. Clustering algorithms (e.g., K-means) can be applied to these embeddings to identify topic clusters. The pre-trained language model can also be used to generate summaries to create topic descriptions for each cluster.

A hybrid approach that combines multiple methods above, for example, is another possible approach. For example, topic modeling can be used to identify initial topics. These topics can be refined using NER and knowledge graph techniques, and descriptions can be generated using transformer-based summarization.

Active learning and human-in-the-loop is another possible approach. Initially, an automated approach (e.g., topic modeling) can be used to generate initial topic maps. The initial topics can be presented to human experts for refinement and validation. Feedback can be used to improve the automated generation process iteratively.

Domain-specific ontologies is another possible approach. If available, existing domain-specific ontologies or taxonomies (e.g., a table of contents) can be used to guide the topic map creation. Content items can be mapped to the most relevant concepts in the ontology, using techniques, like semantic similarity or supervised classification, or simply based on a structural association of the content items to a topic within a target dataset (e.g., pages in the same chapter).

Citation network analysis is another possible approach. For academic or research-focused datasets, citation networks can be analyzed to identify key papers or clusters of papers representing important topics or subfields.

Temporal topic modeling is another possible approach. For datasets with a temporal component, techniques like dynamic topic modeling can be used to capture how topics evolve over time, creating time-sensitive topic maps.

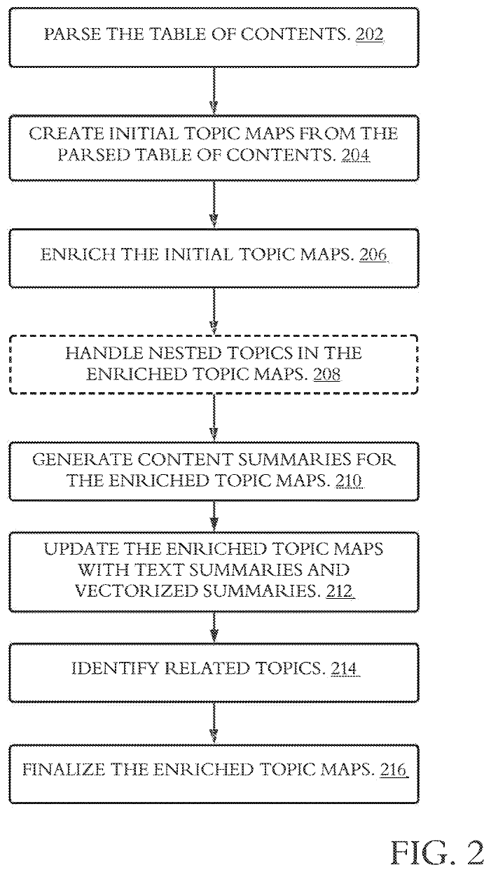

FIG. 2 is a flowchart of a process for topic map generation from online documentation of target dataset(s) 150 according to an embodiment of the disclosure.

The process starts with a corpus of online documentation that has a main table of contents page and multiple web pages (e.g., hypertext markup language (HTML) pages), each corresponding to a section or subsection of the documentation. The table of contents is parsed (operation 202). This can be accomplished using a web scripting library to parse the table or contents page. The hierarchy of topics and their corresponding URLs is extracted based on the parsing.

Initial topics maps are created (operation 204). For each entry in the parsed table of contents, a topic map is created that encompasses a topic name (e.g., the title of the section/subsection), a description that is initially left blank or a placeholder to be filled in or replaced by a later step of the process, and content item references (e.g., URLs) to corresponding web pages (e.g., HTML pages) of the documentation.

The initial topics maps are enriched (operation 206). For each topic map, the corresponding web pages are fetched and parsed, and relevant information for enriching the topic map is extracted from the corresponding web pages. The extracted information includes brief descriptions or meta descriptions (e.g., from certain paragraphs or certain sections of the corresponding web pages). Additionally, or alternatively, a machine learning-based approach, such as a transformer-based approach, is used to extract a summary from the correspond web pages.

Optionally, nested topics are handled (operation 208). If the table of contents has a hierarchical structure, nested topics maps are created, where parent topics include their child topics, and child topics include a reference to their parent topic.

Content summaries are generated (operation 210). For each web page or for a collection of corresponding web pages, a brief summary of its content is generated. For example, a transformer-based approach may be used to generate the brief summary.

The topics maps are updated with the generated summaries (operation 212). This includes adding the generated summaries to the corresponding topic maps.

Related topics are identified (operation 214). For example, a similarity, such as cosine similarly on TF-IDF vectors, can be used to find related topics. This includes creating TF-IDF vectors for topic descriptions, calculating cosine similarity between topics, and adding the top-N related topics to each topic map.

The topic maps are finalized (operation 216). This includes combining the information gathered into a final set of topic maps. This may also include ensuring that the required fields are present and formatting the topic map according to the required structure.

### 3.3 Topic Vault

Referring back to FIG. 1, a topic map 140 may contain a topic name or identifier 142, a description 144 of the topic, and one or more content item references 146 (e.g., as URLs or URIs). A topic map 140 may additionally contain one or more related topics and hierarchical information reflecting parent or child relationships between topics.

The topic vault 130 functions as the storage and retrieval system for topic maps 140 and content item references 146. The topic vault 130 enables efficient identification and access to relevant topic maps for query processing.

In an embodiment, the topic vault 130 is implemented as a high-performance, distributed database system. The topic vault 130 is designed to handle large-scale storage and rapid retrieval of structured data. The topic vault 130 utilizes a combination of technologies to optimize for different access patterns. The underlying storage is built on a distributed SQL or NoSQL database.

In an embodiment, to support the efficient similarity search for identifying relevant topic maps, the topic vault 130 incorporates a vector database component. This could be implemented using specialized vector search engines optimized for high-dimensional nearest neighbor search, useful for quickly finding topic maps that are semantically similar to incoming queries.

In an embodiment, the topic maps 140 stored in the topic vault 130 are structured as complex objects, each including any of the following: a unique identifier, the topic name, the topic identifier, the topic description, the topic summary, a vector representation (e.g., an embedding) of the topic (for similarity matching), metadata such, as creation date, last updated date, and associated tenant ID, or a list or array of references to content items 146 relevant to the topic.

In an embodiment, the content item references 146 are stored as lightweight pointers or identifiers, rather than the full content, to optimize storage and retrieval efficiency. These references include any of the following: unique identifiers for the content items in the target dataset(s) 150 (e.g., in the form of URIs or URLs), brief metadata about the content items (e.g., title, type, creation date), or relevance scores indicating how strongly each item relates to the topic.

In an embodiment, when the topic scope AI agent 110 needs to identify relevant topic maps for a given query, it sends a request to the topic vault 130. This request includes any of the following: the query vector (a semantic representation of the query as an embedding), the tenant ID (for data isolation), or any additional filtering criteria. The topic vault 130 then performs a high-speed similarity search using its vector database component. The topic vault 130 returns a ranked list of the most relevant topic maps along with their associated content item references.

In an embodiment, to handle the multi-tenant nature of the system, the topic vault 130 implements data sharding and partitioning strategies. Topic maps and content references are partitioned by tenant ID, ensuring data isolation and allowing for efficient scaling as the number of tenants grows. Each partition might be further sharded based on topic characteristics or access patterns to distribute the load across multiple nodes.

In an embodiment, the topic vault 130 implements a robust caching layer using a distributed caching system. This cache stores frequently accessed topic maps and query results, significantly reducing latency for common queries and decreasing the load on the primary storage system.

In an embodiment, to maintain consistency and durability, the topic vault 130 employs a multi-node replication strategy. This ensures that topic maps and content references are available even in the face of individual node failures. Techniques, such as read-repair or anti-entropy processes, can be used to maintain consistency across replicas.

In an embodiment, the topic vault 130 provides APIs for both read and write operations. The topic forge 120 uses write APIs to update or create new topic maps based on its analysis of the target dataset(s) 150. The topic scope AI agent 110 uses read APIs to retrieve relevant topic maps and content references for query processing.

In an embodiment, the topic vault 130 implements versioning for topic maps, allowing the system to track changes over time. This is useful for maintaining the accuracy of responses and enabling features like historical analysis or rollback capabilities.

### 3.4 Topic Maps

In an embodiment, each topic map 140 contains a topic name or ID 142 of the target dataset(s) 150 and a set of references 146 to content items 152 of the target dataset(s) 150. The topic 142 represents a specific subject or theme within the larger target dataset(s) 150. The topic 142 serves as the central concept around which the related content items are organized. Some non-limiting examples of topics 142 could include “Introduction to Python,” “Climate Change Effects,” or “20th Century American Literature.” The topic map 140 may be generated based on contents of the one or more tags determined from the raw text submission or normalized input. The topic 142, description 144, and/or content item references 146 may be generated based on the one or more tags and/or the content items 152.

The set of references 146 acts as pointers or links to specific content items 152 within the target dataset(s) 150. The content items 152 are discrete pieces of information within the target dataset(s) 150. For example, a content item 152 can be a document, an article, a web page, a database entry, or any other form of structured or unstructured data. A content item 152 is deemed relevant to the topic of its associated topic map 140. The content items 152 references by a topic map 140 are specifically chosen for their relevance to that topic. This relevance ensures that the information provided to the generative AI agent 160 is focused and pertinent to the query at hand. The target dataset(s) 150 represent a knowledge base and the broader collection of information from which the topic maps 140 are derived.

Topic maps 140 provide an organized knowledge structure. Topic maps 140 create a structured representation of knowledge within the target datasets(s) 150. This organization facilitates more efficient and accurate information retrieval. Topic maps 140 provide contextual relevance. By grouping related content items 152 under specific topics, the topic scope AI agent 110 can provide contextually relevant information to the generative AI agent 160. The structure of the topic maps 140 allows for easy addition of new topics as the target dataset(s) 150 grow or evolve over time. The topic maps 140 provide for focused information retrieval. When responding to a query, the AI agent 160 can focus on the most relevant subset of information, rather than processing the entirety of the target dataset(s) 150. The topic maps 140 provide noise reduction. By pre-selecting relevant content items 152 for each topic, the likelihood of irrelevant or noisy information being considered by the AI agent 160 is reduced. The topic maps 140 provide flexibility. The structure of the topic maps 140 allows for various types of content items to be referenced accommodating diverse target dataset(s) 150 and information types. The topic maps 140 provide hierarchical potential. The structure of the topic maps 140 support hierarchical relationships between topics, allowing for more complex knowledge representation. The topic maps provide improved accuracy. By constraining the AI agent 160's knowledge to carefully curated, topic-specific content, the topic scope AI agent 110 can potentially reduce hallucinations and improve the accuracy of generated responses. The topic maps 140 enable the topic scope AI agent 110 to create a focused, relevant subset of information for a query, allowing the generative AI agent 160 to produce more accurate and contextually appropriate responses while efficiently managing large and diverse target dataset(s) 150.

### 3.5 Generative AI Agent

The generative AI agent 160, incorporating the large language model (LLM) 165, generates contextually relevant and accurate responses to queries. This component leverages NLP and machine learning techniques to understand queries and generate human-like text responses.

In an embodiment, the generative AI agent 160 receives a query along with the plurality of references to content items from the identified subset of topic maps. The agent 160 acts as an orchestrator, preparing the input for the LLM 165 and managing the generation process. In an embodiment, the LLM 165 is based on a state-of-the-art transformer architecture, such as GPT (Generative Pre-trained Transformer) or a similar model. The LLM 165 is pre-trained on a vast corpus of text data, enabling it to understand and generate human-like text across a wide range of topics and styles. In an embodiment, the LLM 165 is fine-tuned for the specific task of generating responses within the constraints provided by the topic maps and content references.

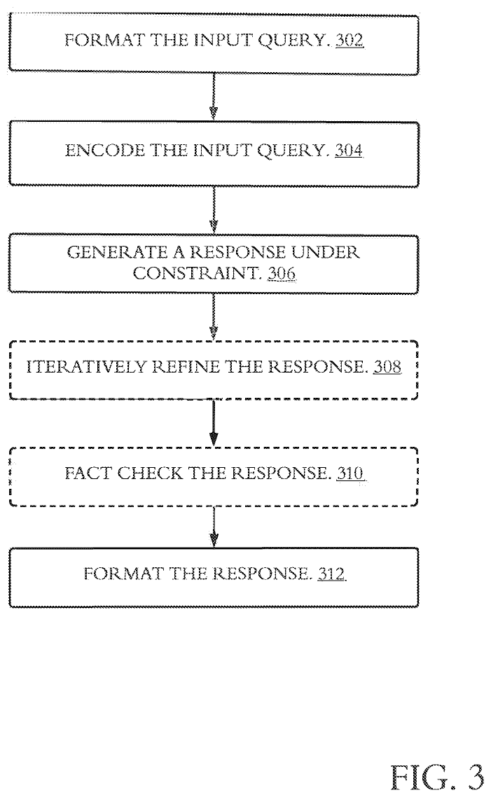

FIG. 3 is a flowchart of a process performed by the generative AI agent 160 and LLM 165 in processing a query received from the topic scope AI agent 110 according to an embodiment of the present disclosure.

The process involves input preparation (Operation 302). The generative AI agent 160 formats the second query, and the content item references into a structured prompt for the LLM 165. This prompt includes special tokens or formatting to delineate the query, the relevant topics, and the constraints imposed by the content references.

The process also involves context encoding (Operation 304). The LLM 165 encodes the provided context (query and content references) into its internal representation using a combination of token embeddings and positional encodings.

The process further involves constrained generation (Operation 306). The LLM 165 generates a response using its trained parameters but with the constraint of using information provided in the content references. This constraint is enforced through careful prompt engineering and potentially through modified decoding algorithms that restrict the model 165's output to information present in the given context.

The process optionally involves iterative refinement (Operation 308). The generative AI agent 160 may employ a multi-step generation process, where initial outputs are analyzed and refined to ensure adherence to the provided constraints and to improve relevance and coherence.

The process optionally involves fact checking (Operation 310). The generated response might be cross-referenced against the provided content references to ensure factual accuracy and adherence to the constrained information set.

The process involves response formatting (Operation 312). The final generated text is formatted by the generative AI agent 160 into a structured response suitable for return to the topic scope AI agent 110.

While constrained generation (operation 306) involves only using information provided in the content references in an embodiment, the constraint on the generative AI agent 160 and LLM 165 is software in another embodiment. This allows for a more flexible use of information while still maintaining a strong emphasis on the provided content references. In this scenario, the aim is to use the information from the content references as the primary source, but some degree of additional information or context needs to be incorporated.

In this softer constraint embodiment, the generative AI agent 160 is configured to prioritize information from the provided content references while allowing for some supplementary information from the LLM 165's pre-trained knowledge. The goal is to enhance the response with additional context or related information when appropriate without straying too far from the core information provided in the content references. For example, 70-80% of the information in the generated response may come directly from the provided content references. For example, this means that for every 100 tokens or semantic units in the response, 70-80 would be traceable to the content references. Another example, 50-70% of the information in the generated response could come from the content references. This allows for a more balanced mix of referenced information and supplementary knowledge from the LLM 165.

In an embodiment, the generative AI agent 160 utilizes information weighting. The generative AI agent 160 assigns higher weights to information from the content references during the generation process. This is achieved through prompt engineering or by modifying the attention mechanisms in the LLM 165 to give preference to tokens associated with the reference content.

In an embodiment, the generative AI agent 160 utilizes confidence thresholds. The generative AI agent sets confidence thresholds for incorporating non-referenced information. For example, if the LLM 165 generates a statement not found in the references, it would only be included if the model 165's confidence in that statement exceeds a high threshold (e.g., 90% confidence).

In an embodiment, the generative AI agent 160 incorporates a fact-checking module. The fact-checking module verifies generated content against the references. This module allows non-referenced information to pass if it does not contradict the references and enhances the response's quality.

In an embodiment, the generative AI agent 160 utilizes semantic similarity scoring. The generative AI agent 160 employs semantic similarity measures to ensure that even when incorporating additional information, the overall meaning and intent closely align with the content references.

In an embodiment, the generative AI agent 160 employs dynamic constraint adjustment. The generative AI agent 160 dynamically adjusts the strictness of the constraint based on various factors, such as query complexity, available reference information, and user preferences. For instance, it might allow more flexibility for broad, open-ended queries while maintaining tighter constraints for specific, fact-based questions.

In an embodiment, the generative AI agent 160 employs labeling or marking. The generated response includes subtle markers or metadata indicating the parts of the response that are directly from references and those that are supplementary. This transparency could be valuable for users who need to distinguish between referenced and inferred information.

In an embodiment, the generative AI agent 160 continuously monitors the proportion of referenced vs. non-referenced information in the generated responses. This is done by token-level tracking, semantic unit analysis, periodic auditing, or combination thereof. Token-level tracking involves keeping a count of tokens that can be directly attributed to the references versus those that are generated based on the LLM 165's general knowledge. Semantic unit analysis breaks down the response into semantic units (e.g., facts, statements, or concepts) and calculates the percentage that can be traced back to the references. Periodic auditing involves regularly sampling generated responses for manual or automated review to ensure adherence to the desired ratios of referenced information.

The softer constraint approach allows the generative AI agent 160 and LLM 165 to produce more nuanced and comprehensive responses. For example, when answering a query about a specific historical event, the system could primarily use information from the provided references while also incorporating relevant contextual information or related facts that enhance the user's understanding even if those additional details were not explicitly in the references.

This softer constraint approach strikes a balance between the accuracy and reliability offered by strict adherence to referenced information and the depth and richness that can come from leveraging the broader knowledge base of the LLM 165. It allows for more flexible and potentially more helpful responses while maintaining a strong grounding in the verified information provided by the topic maps and content references.

In an embodiment, the generative AI agent 160 implements one or more techniques to enhance the quality and reliability of the generated responses, including any of the following: temperature control, nucleus sampling, repetition penalties, length optimization, or a combination thereof. Temperature control involves adjusting the randomness in the LLM 165's output to balance between creativity and determinism. Top-k and top-p (nucleus) sampling involves limiting the token selection during generation to maintain coherence and relevance. Repetition penalties discourage the model from repeating information or getting stuck in loops. Length optimization ensures the generated response is appropriately sized for the query and available information.

In an embodiment, to handle the multi-tenant nature of the system, the generative AI agent 160 maintains isolated execution environments for each tenant, ensuring that no cross-tenant information leakage occurs during the generation process.

In an embodiment, the generative AI agent 160 employs a batching mechanism to efficiently process multiple queries in parallel, maximizing the utilization of the LLM 165's computational resources. This is particularly useful in a multi-tenant environment, where numerous queries might be processed simultaneously.

As instructed by the prompt sent from the topic scope AI agent 110, the generative AI agent 160 ensures that the LLM 165 only, mostly, or significantly uses information from the provided content references, mitigating the risk of hallucination or incorporation of out-of-scope information. This constrained generation distinguishes from more general-purpose language models, ensuring higher accuracy and reliability in the generated responses. By constraining the LLM 165's output to relevant, verified information from the topic maps, the generative AI agent 160 and LLM 165 enable the topic scope AI agent 110 to generate highly relevant, accurate, and contextually appropriate responses to queries.

### 4.0 Example Methods for Topic Maps for Constrained Retrieval Augmented Generation

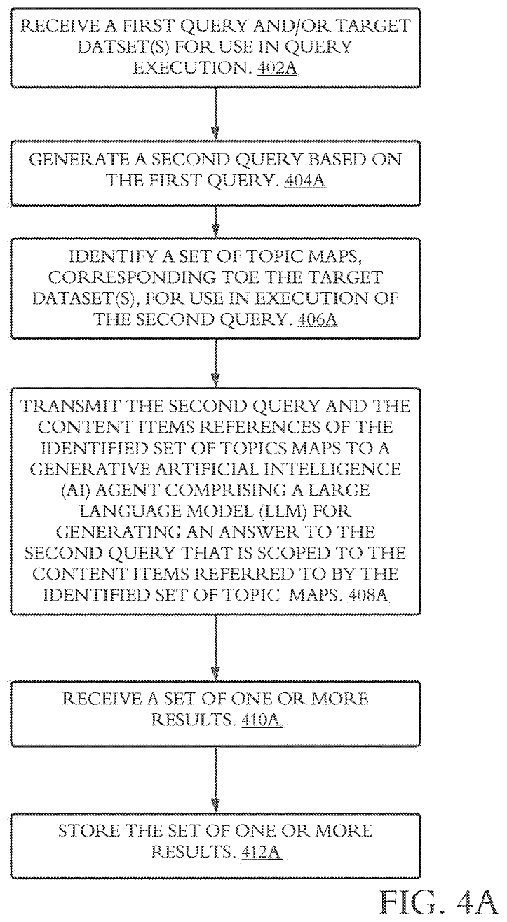

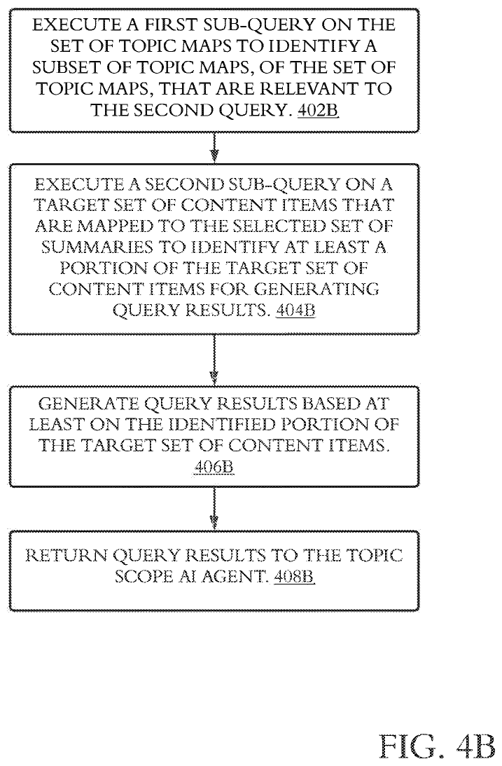

FIG. 4A is a flowchart of a method for topics maps for constrained retrieval augmented generation according to some embodiments of the present disclosure.

As a pre-processing step (step 1 of FIG. 1) to the method of FIG. 4A, a set of topic maps 140 is generated based on one or more target datasets 150. This process is executed by the topic forge 120 component and involves data analysis and NLP techniques to distill structured, topic-oriented knowledge from the raw datasets 150.

In an embodiment, the pre-processing process begins with the ingestion of the one or more target datasets 150 into the topic forge 120. This involves reading data from various sources that could include distributed file systems, cloud object storage, or database systems. The ingestion process may utilize data streaming technologies, platforms, or cloud services for streaming data ingestion, ensuring scalability and fault tolerance.

In an embodiment, the raw data undergoes cleaning and normalization processes. This includes handling missing values, removing duplicates, standardizing formats, and resolving inconsistencies. Distributed data processing frameworks are employed for distributed data processing, allowing for efficient handling of large-scale datasets.

In an embodiment, for unstructured or semi-structured data, text extraction techniques are applied. This involves parsing PDFs, extracting text from HTML, or processing image data using Optical Character Recognition (OCR). The extracted text then undergoes preprocessing, including tokenization, lowercasing, stop word removal, and stemming or lemmatization.

In an embodiment, named entity recognition is applied to the one or more target dataset(s) 150 to identify key concepts and entities within the one or more target dataset(s) 150. This process identifies and classifies named entities in the text into predefined categories, such as personal names, organizations, locations, etc. Deep learning models trained on relevant corpora are used for this task.

In an embodiment, topic modeling is performed. Techniques, such as Latent Dirichlet Allocation (LDA), Non-Negative Matrix Factorization (NMF), or more advanced neural topic models are employed to discover latent topics within corpus 150. These algorithms analyze patterns of word co-occurrences to identify coherent themes.

In an embodiment, topic forge 120 conducts hierarchical topic structuring to create a more organized knowledge structure. This involves hierarchical LDA or custom algorithms that cluster topics into a tree-like structure, allowing for different levels of granularity in the topic maps.

In an embodiment, topic forge 120 performs cross-dataset topic alignment. In the case of multiple datasets 150, an additional step of aligning and merging topics across datasets is performed. This involves techniques, like transfer learning or domain adaptation, that create coherent topics that span multiple data sources.

In an embodiment, content item association is performed by topic forge 120. For each identified topic, relevant content items 152 from the dataset(s) 150 are associated. This process uses techniques like TF-IDF (Term Frequency-Inverse Document Frequency) scoring or more advanced semantic similarity measures based on word embeddings or sentence transformers.

In an embodiment, topic forge 120 performs topic description generation where, for each topic, a concise description is generated. This involves extractive summarization techniques to select representative sentences from associated content items or abstractive summarization using sequence-to-sequence neural network models to generate descriptions.

In an embodiment, topic forge 120 performs metadata enrichment where topics and their associated content items are enriched with metadata such as relevance scores, confidence levels, and source dataset identifiers. This metadata is used for downstream processes in query handling and response generation.

In an embodiment, topic forge 120 constructs vector representations to facilitate efficient similarity search during query processing where each topic is encoded into a dense vector representation. This uses embeddings or custom neural network encoders trained on the specific domain of the datasets 150.

In an embodiment, automated and potentially manual processes are implemented to assess the quality and coherence of generated topics. This involves statistical measures of topic coherence, diversity checks, and expert review for critical domains.

In an embodiment, a versioning system is implemented to track changes in the topic maps over time. This includes maintaining a changelog that records significant updates, additions, or deletions of topics.

The generated topic maps 140, including the associated metadata and vector representations, are stored in the topic vault 130. This involves a combination of traditional database systems for structured data and vector databases for efficient similarity search capabilities.

The topic maps 140 are indexed to optimize for fast retrieval during query processing. This involves building inverted indices, setting up efficient data structures for vector search, and potentially pre-computing common query results for caching.

This pre-processing step transforms raw, unstructured data from the target datasets 140 into a rich, structured set of topic maps 140. These topic maps 140 serve as the foundation for the method of FIG. 1, enabling efficient and accurate responses to user queries by providing a well-organized knowledge base for the topic scope AI agent 110 to work with.

Turning now to a discussion of the method of FIG. 4A, the method starts with the query gateway 170 receiving a first query and/or an identification of a target dataset(s) for use in query execution (operation 402A). The first query and/or an identification of the target dataset(s) may be received via user input. In one example, a system receives the first query with an identification of the target dataset(s) with explicit or implicit instructions for limiting the scope of query results to the target dataset(s). In another example, the system receives the first query and determines the target dataset(s) as a function of one or more attributes of the first query. The system determines the target dataset based on a source of the query, a time when the query is received, an entity associated with the query, etc. In another example, the system determines the target dataset(s) based on a stored configuration.

Alternatively, or additionally, the system may receive a request for a set of topic maps for the target dataset(s). A set of topic maps may be referred to herein as an “information map.” In response to the request for the set of topic maps (e.g., the information map), the system determines the set of topic maps as further described below with reference to operation 408A. The system then presents the set of topic maps on an interface or transmits the set of topic maps to a user device.

In an embodiment, a system component, within the intermediate network 180, receives the first query and/or an identification of the target dataset. The intermediate network 180 could be implemented, for example, as a content delivery network (CDN) or edge network. In an embodiment, the query gateway 170 performs various operations with respect to receiving the first query including any of the following: load balancing, protocol handling, authentication, authorization, tenant identification, rate limiting checks, query normalization, metadata enrichment, logging and monitoring, DDoS protection, caching checks, query queuing, making an initial routing decision, telemetry initiation (request tracing), or any other suitable operations.

Once these steps are completed, the query gateway 170 prepares to forward the now-validated, authenticated, and enriched query to the appropriate instance of the topic scope AI agent 110 for further processing (operation 2 of FIG. 1).

In an embodiment, the system generates a second query based on the first query (operation 404A), for transmission to a search engine (e.g., a generative AI agent comprising an LLM). The second query, as referred to herein, may be the same as the first query, a modification of the first query, or otherwise generated based at least in part on the first query. Accordingly, generating the second query may simply include generating a message for transmission to the search engine that incorporates the first query, or a modification thereof. The second query may be generated, based on the first query, by the topic scope AI agent 110, the query gateway 170, or another suitable component of network 100.

Generating the second query based on the first query can involve various techniques to enhance, clarify, or refocus the original query to improve the relevance and accuracy of the results. The choice of method(s) for generating the second query depends on various factors, such as the nature of the target dataset, the structure of the topic maps, the complexity of the original query, and the specific goals of the system. A combination of the following techniques can be employed to create the most effective second query.

In an embodiment, query expansion is performed where synonyms or related terms are added to the first query to broaden the scope of the query. For example, if the first query is “car maintenance,” then second query could be “car maintenance OR automobile repair OR vehicle upkeep.”

In an embodiment, query refinement is performed where specific terms are added to the first query to narrow down the focus of the query. For example, if the first query is “python programming”, then the second query could be “python programming for data science.”

In an embodiment, query disambiguation is performed if the first query is ambiguous. In this case, multiple specific queries are generated as the second query. For example, if the first query is “jaguar”, then the multiple specific queries could be “jaguar animal”, “jaguar car”, and “jaguar operating system”.

In an embodiment, context-based augmentation is performed where the user's history or profile is used to add contextual information. For example, if the first query is “best restaurants”, then the second query could be “best Italian restaurants in [user's location]”.

In an embodiment, intent classification and query rewriting is performed. The intent of the first query is classified, and the first query is rewritten to better match that intent. For example, if the first query is “how to lose weight”, then the second query could be “effective weight loss methods and diet plans”.

In an embodiment, entity recognition and linking is performed. Named entities in the first query are identified and linked to a knowledge base for more precise querying. For example, if the first query is “Obama presidency”, then the second query could be “Barack Obama United States presidency 2009-2017”.

In an embodiment, query segmentation is performed when the first query is complex and thus broken down into simpler sub-queries as the second query. For example, if the first query is “compare iPhone and Samsung Galaxy features and prices”, then the simpler sub-queries could be “iPhone features”, “Samsung Galaxy features”, “iPhone pricing”, and “Samsung Galaxy pricing”.

In an embodiment, spelling correction and query normalization is performed where spelling errors are corrected and terms normalized (e.g., singularization/pluralization). For example, if the first query is “best laptops 2023”, then the second query could be “best laptops 2023”.

In an embodiment, query translation is performed. If the system supports multiple languages, the first query is translated to the language of the target dataset(s) 150. For example, if the first query is in Spanish, such as “mejor coche eléctrico”, then the second query could be in English as “best electric car”.

In an embodiment, time-based query augmentation is performed. Time-related terms are added to the first query to make the query more current or specific. For example, if the first query is “Olympic games”, then the second query could be “Olympic games 2024 Paris”.

In an embodiment, a question to declarative statement conversion operation is performed where converting question-format queries into declarative statements better matches with topic maps. For example, if the first query is “What are the symptoms of COVID-19?”, then the second query could be “COVID-19 symptoms and diagnosis”.

In an embodiment, aspect-based query generation is performed. In particular, multiple queries are generated as the second query based on different aspects of the first query. For example, if the first query is “climate change”, then the multiple queries could include “climate change causes”, “climate change effects”, and “climate change solutions”.

In an embodiment, query abstraction is performed when very specific queries are generalized to match broader topics in the topic maps. For example, if the first query is “how to change oil in a 2015 Toyota Camry”, then the second query could be “car maintenance oil change procedures”.

In an embodiment, keyword extraction and reformulation are performed. Key terms are extracted from the first query, and the first query is reformulated into a more structured query. For example, if the first query is “I need to know about the American Civil War”, then second query could be “American Civil War history causes and effects”.

In an embodiment, query expansion using word embeddings is performed to find semantically similar terms and expand the first query. For example, if the first query is “artificial intelligence”, then the second query could be “artificial intelligence machine learning neural networks”.

In an embodiment, the topic scope AI agent identifies a set of topic maps, corresponding to the target dataset(s), for use in execution of the second query (operation 406A). A topic map identifies a particular topic associated with one or more content items in the target dataset(s). The topic map, for the particular topic, further identifies references to the one or more content items that are associated with the particular topic. Additionally, the topic map may further include a description or summary of the one or more content items that are associated with the particular topic.

Identifying the set of topic maps may include accessing the set of topic maps from a repository of pre-computed topic maps for various datasets including the target dataset(s). The topic maps may be pre-computed to avoid runtime delays for query execution. Alternatively, or additionally, identifying the set of topic maps may include computing the set of topics maps, in real-time, subsequent to receiving an identification of the target dataset(s).

Various techniques can be used to identify the set of topic maps, corresponding to the target dataset(s), for execution of the second query. The choice of method(s) depends on numerous factors, such as the size and structure of the topic map set, the nature of the queries, computational resources available, and the specific requirements of the system in terms of accuracy and speed. In fact, a combination of techniques can be used.

For large groups of topic maps, the topic vault 130 can use indexing techniques (e.g., inverted index) or approximate nearest neighbor search to speed up the matching process. The topic vault 130 can be designed to handle growth in both the number of topic maps and query volume. The topic vault 130 can allow for easy addition or modification of topic maps without requiring a complete system overhaul. The topic vault 130 or the topic scope AI agent 110 can incorporate a feedback mechanism (e.g., based on reinforcement learning) to learn from user interactions and improve the relevance matching over time.

Various techniques may be employed by the topic scope AI agent 110 or by the topic scope AI agent 110 and the topic vault 130 to identify a set of the topic maps 140 that are to be used for query execution. Any or a combination of the techniques may be used in an embodiment.

One possible technique is keyword matching where keywords are extracted from the query using techniques such as TF-IDF. These keywords are compared against the topic names and descriptions in each topic map. And topic maps that have a high overlap of keywords are selected.

Another technique uses a vector space model. The query and the topic map descriptions are converted into vector representations (e.g., using TF-IDF or word embeddings). The cosine similarity is computed between the query vector and each topic map vector, and topic maps with similarity scores above a certain threshold are selected for inclusion in the subset of relevant topic maps.

Another technique employs semantic similarity using word embeddings. Here, pre-trained word embeddings (e.g., Word2Vec, GloVe, or FastText) are used to represent words in the query and topic maps. The semantic similarity between the query and each topic map using a similarity measure, such as cosine distance, is calculated. Topic maps with the highest semantic similarity scores are selected for inclusion in the subset of relevant topic maps.

Another technique uses topic modeling. Topic modeling techniques (e.g., Latent Dirichlet Allocation) are applied to the entire set of topic maps 140. The topic distribution for the given query is inferred. Topic maps that have a high probability for the same topics as the query are selected for inclusion in the subset of relevant topic maps.

Hierarchical matching is another possible technique. If the topic maps are organized hierarchically, matching topic maps to the query may proceed from the top-level topics and drill down. This can be particularly efficient for large sets of topic maps.

Machine learning (ML) classification is another possible technique. A multi-label classifier (e.g., using neural networks or random forests) is trained on the topic maps. The trained classifier predicts the most relevant topic maps for the given query.

Graph-based relevance is another possible technique. Topic maps are represented as nodes in a graph with edges representing relationships between topics. A graph algorithm is used to rank the relevance of topic maps based on the query.

Fuzzy string matching is another possible technique. Fuzzy string matching algorithms (e.g., Levenshtein distance) can be used to handle slight variations or misspellings in the query to match the query against topic names and descriptions.

Named entity recognition (NER) is another possible technique. NER is applied to both the query and topic maps to identify key entities. Topic maps that contain the same entities as the query are then matched.

An ensemble approach is another possible technique. Here, multiple methods above are combined, and a voting or weighted scoring system is used to select the most relevant topic maps.

Query expansion and matching is another possible technique. The query is expanded using techniques like synonyms, hypernyms, or related terms from a knowledge base. This expanded query is matched against the topic maps.

Contextual embeddings are another possible technique. Contextual embedding models, like BERT or GPT, are used to generate representations for both the query and topic maps. Similarities between the query and the topic maps are calculated in this contextual embedding space.

Relevance feedback is another possible technique. Initially, a subset of topic maps is selected using one of the above methods. Relevance feedback techniques (e.g., Rocchio algorithm) are then used to refine the selection based on user interaction or performance metrics.

Continuing the discussion of the process of FIG. 4A, the topic scope AI agent 110 communicates with the generative AI agent 160 to produce a response (operation 408A; see also operation 4 of FIG. 1). The topic scope AI agent sends at least two pieces of information to the generative AI agent 110: (1) the second query and (2) the content item references to content items from each relevant topic map.

The second query is either the same as the first query or a modified version of it. The second query represents the specific question or task that the AI agent 160 needs to address.

The content item references are the links or pointers to specific content items within the target dataset(s) 150. These references come from each topic map in the subset identified as relevant to the second query. This collection of content item references defines the scope of information that the AI agent 160 should consider.

The generative artificial intelligence (AI) agent 160 is responsible for producing the answer or response to the second query. The AI agent 160 includes an LLM 165 that is trained on vast amounts of text data and can understand and generate human-like text. The LLM 165 may be based on GPT, BERT, or other like transformer architectures, for example.

The topic scope AI agent 110 tasks the AI agent 160 to produce a response to the second query that the AI agent 160 generates dynamically and not simply by retrieving information from a database. The generated answer is constrained to (scoped to) the information contained in the referenced content items. This scoping aims to improve the accuracy and relevance of the generated answer.

The topic scope AI agent 110 guides the generative AI agent 160 to produce answers that are constrained to the referenced content items. This process involves crafting prompts that instruct the generative AI agent 160 on how to use the provided information.

In an embodiment, the topic scope AI agent 110 receives a set of one or more query results from the generative AI agent 160 (operation 410A) and stores the one or more query results (operation 410A). These steps are executed by the topic scope AI agent 110 in conjunction with other system components.

In an embodiment, the process of receiving the results begins with the generative AI agent 160 completing its task of generating an answer based on the constrained information provided. This generated answer, along with any associated metadata, is then passed back to the topic scope AI agent 110. In an embodiment, the received results are structured in a standardized format, such as JSON or Protocol Buffers, to ensure consistent handling across different components of the system.

In an embodiment, upon receiving the results, the topic scope AI agent 110 performs several operations, including result validation, metadata enrichment, tenant association, or version. The AI agent 110 may check the integrity and format of the received data, ensuring it meets expected structures and contains all necessary fields. The AI agent 110 may append additional metadata to the results, such as generation timestamp, processing time, sources of information used, and confidence scores. The AI agent 110 may tag the results with the appropriate tenant identifier to maintain data isolation in the multi-tenant environment. The AI agent 110 may add version information, if applicable, to track different iterations of responses to similar queries.

In an embodiment, the storage process (operation 412A) involves persisting the received results in a manner that allows for efficient retrieval and analysis. This may include storing the results in main memory, in primary storage, in a search index, in vector storage, in a caching layer, or at another suitable storage location.

In an embodiment, the system presents the query results on an interface. This interface could be a graphical user interface (GUI) accessible through a web browser or a dedicated application. The presentation of results may include various elements such as the original query, the generated response, relevant topic maps used, and confidence scores. The interface may also feature interactive elements allowing users to explore the sources of information, request further clarification, or provide feedback on the relevance and accuracy of the results. Additionally, the system might employ data visualization techniques to represent complex relationships between topics or to highlight key insights from the generated response

In an embodiment, the system transmits the query results to an endpoint associated with a user or user device. The endpoint could be a variety of destinations, such as a mobile application, an email address, a messaging platform, or an API endpoint for integration with other systems. The transmission may occur through secure protocols like HTTPS to maintain data privacy and integrity. Depending on the user's preferences or system settings, the results could be pushed immediately or queued for scheduled delivery. The transmitted data package could include the primary query response as well as associated metadata, confidence scores, and links to source materials. For endpoints with limited bandwidth or display capabilities, the system may optimize the content, sending a condensed version of the results with options to request more detailed information. Additionally, the transmission process could incorporate features like delivery confirmation and read receipts to ensure the query results have been successfully received and accessed by the intended recipient.

FIG. 4B illustrates steps of a method performed by the generative AI agent 160 for topics maps for constrained retrieval augmented generation (RAG) in accordance with an embodiment of the disclosure.

The process begins with the execution of a first sub-query on a set of topic maps (operation 402B). This initial step identifies a subset of topic maps that are relevant to the given query. To accomplish this, the system compares semantic vector embeddings generated for the query to semantic vector embeddings generated for summaries associated with the topic maps. It then selects a set of summaries that meet predetermined similarity criteria in relation to the query.

Following this initial filtering, the method proceeds to execute a second sub-query (operation 404B). This time, the focus is on a target set of content items that are mapped to the previously selected set of summaries. The goal of this step is to identify a portion of the target set of content items that will be used for generating query results. Similar to the first step, this is achieved by comparing semantic vector embeddings of the query to semantic vector embeddings of the target set of content items.

Once the relevant content items have been identified, the system generates query results (operation 406B). These results are based on the portion of the target set of content items identified in the previous step. This generation process involves synthesizing information from the selected content to produce a coherent and relevant response to the original query.

The final step of the method involves returning the generated query results to the topic scope AI agent 110 (operation 408B). This agent 110 then uses these results for further processing or presents them to the end-user as appropriate.

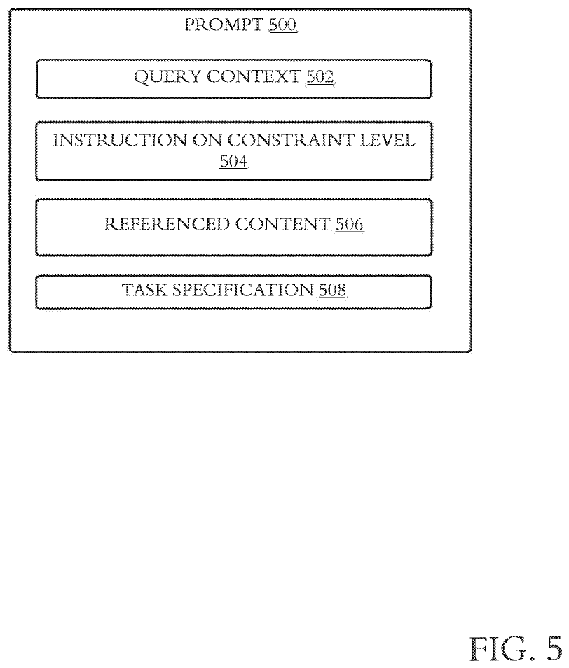

In an embodiment, as depicted in FIG. 5, the topic scope AI agent 110 constructs a prompt 500 with the following components: a query context 502 that encompasses the second query; an instruction on constraint level 504 that includes directions on how strictly the generative AI agent 160 is to adhere to the provided information; the referenced content 506 that includes the content items references from the selected subset of relevant content items or relevant excerpts or summaries from the referenced content items; and a task specification 508 that encompasses clear instructions on what the generative AI agent 160 should do with the referenced content 506.

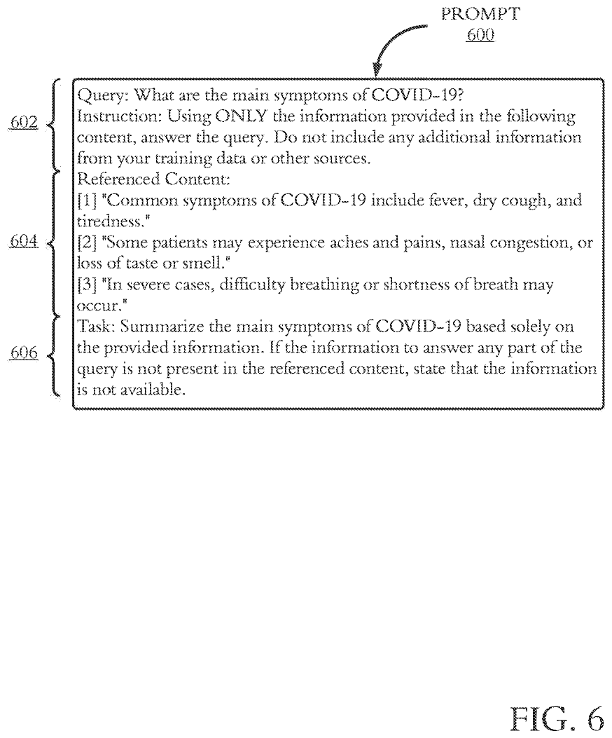

FIG. 6 illustrates an example LLM prompt 600 that imposes a strict constraint level according to an embodiment of the present disclosure. The prompt 600 includes a query 602 and referenced content 604. For the purpose of providing a clear example, instead of references to the content, summaries or digests of the content are included in the prompt 600. The prompt 600 also includes a task specification with instructions on constraint level 606. This prompt 600 strictly constrains the generative AI agent 160 to use only the provided information, explicitly instructing it not to incorporate any external knowledge.

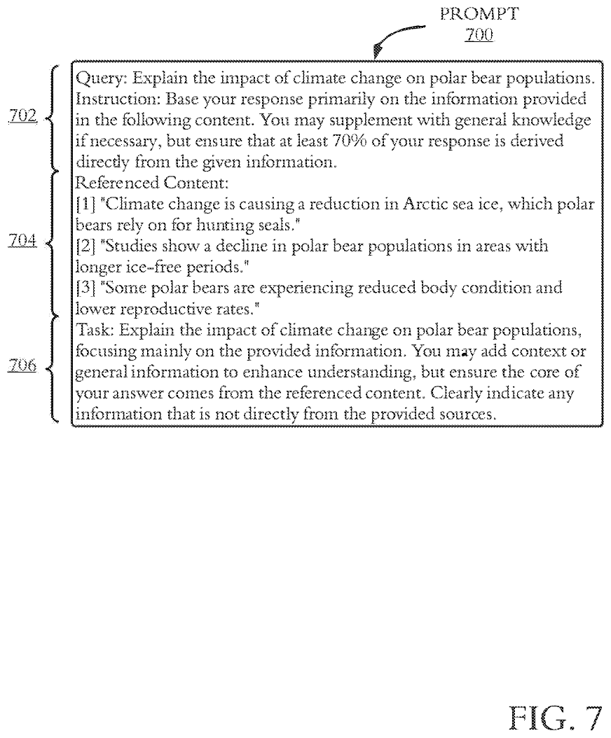

FIG. 7 illustrates an example LLM prompt 700 that substantially or mostly constrains the generative AI model 160 to the provided content according to an embodiment of the present disclosure. The prompt 700 includes a query 702 and referenced content 704. Again, for the purpose of providing a clear example, summaries or digest of the content are included in the prompt 700 instead of references to the content. The prompt 700 also includes a task specification with instructions on constraint level 706. This prompt allows the generative AI agent 160 more flexibility, permitting it to incorporate some additional context or general knowledge while still emphasizing the primacy of the provided information.

In an embodiment, the topic scope AI agent 110 includes additional metadata or structuring elements in the prompt to help the generative AI agent 160 organize its response. For example, the prompt may include any of the following: relevance scores for each piece of referenced content, tags or categories for different types of information, or specific formatting instructions for the output.

In an embodiment, the topic scope AI agent 110 implements a post-processing step to verify that the generated answer adheres to the specified constraints. This involves any of the following: semantic similarity analysis between the answer and the referenced content, fact-checking against the provided information, or calculating the proportion of the response that can be directly attributed to the referenced content.

By constructing these prompts, the topic scope AI agent 110 guides the generative AI agent 160 to produce responses that are appropriately constrained to the referenced content items, either strictly or substantially, while still allowing for coherent and informative answers to the user's queries.

The prepared query and relevant references are used to guide the LLM 165 in generating a response that is both relevant and constrained to the desired scope of information. This approach aims to leverage the strengths of large language models while mitigating some of their common weaknesses, such as hallucination or drift from the intended topic.

The approach allows for highly domain-specific responses by curating the references sent to the AI. By providing specific references, the topic scope AI agent 110 ensures the AI agent 160 works with the most relevant information. This can significantly reduce the chances of the AI generating irrelevant or incorrect information.

It should be noted that the AI agent 160 does not just retrieve pre-written answers but generates new responses based on the provided information. This allows for more flexible and context-appropriate answers.

The AI agent 160 can use its generative capabilities creatively but within the bounds of the provided references. This balance aims to maintain accuracy while allowing for nuanced and tailored responses. By scoping the response to specific content items, the topic scope AI agent 110 aims to minimize the AI agent 160's tendency to generate plausible but incorrect information (hallucination).

The AI agent 160 does not need to search through its entire knowledge base but can focus on the provided references. This can lead to faster response times and more efficient use of computational resources. The system can easily adapt to new or updated information by changing the references sent to the AI agent 160. This allows for up-to-date responses without needing to retrain the entire language model 165.

Since the AI agent 160's response is based on specific referenced content, it is easier to trace the sources of information used in generating the answer. The AI could potentially provide explanations or citations based on the specific content items it used to generate its response.

### 5. GUI Example

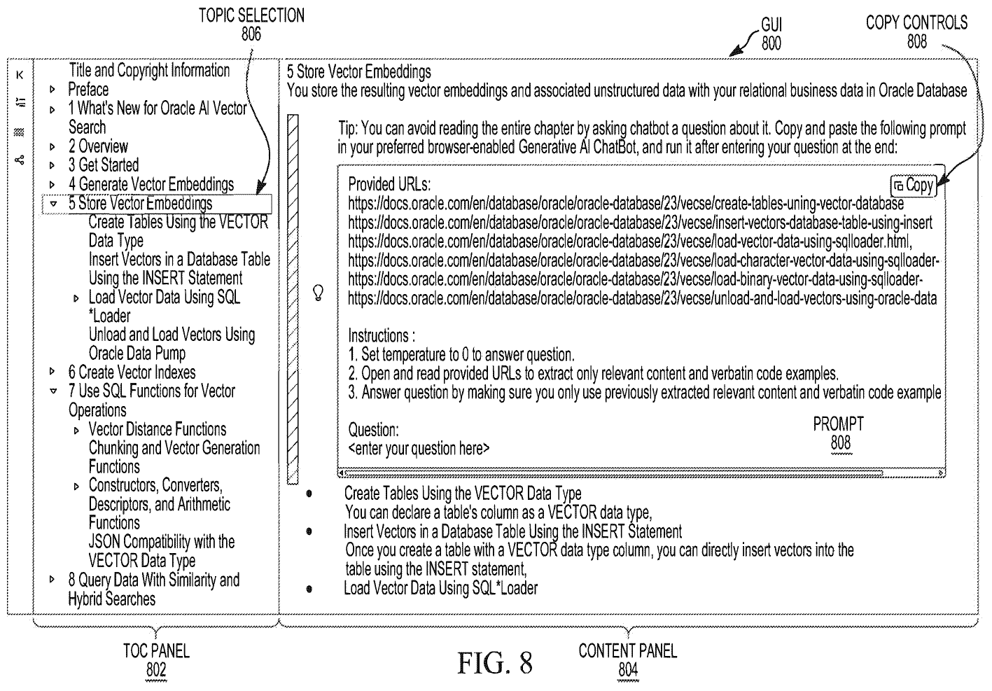

FIG. 8 illustrates a graphical user interface (GUI) 800 designed to provide users with an intuitive and interactive way to navigate online documentation while also leveraging the power of generative AI according to an embodiment of the present disclosure. The GUI 800 is divided into two main panels, the Table of Contents (TOC) panel 802 and the content panel 804, both offering a familiar and efficient layout for browsing documentation.

The TOC panel 802 presents a hierarchical view of the documentation's structure, allowing users to easily navigate through different sections and topics. This panel employs a tree-like structure, with expandable and collapsible nodes representing chapters, sections, and subsections of the documentation. Users can click on any item in the TOC to select a topic of interest.

The content panel 804 dynamically displays the content of the currently selected topic 806 from the TOC panel 802. This panel renders the documentation content in a readable format, supporting rich text formatting, images, code snippets, and other multimedia elements relevant to technical documentation. As users navigate through different topics in the TOC panel 802, the content panel 804 updates in real-time to reflect the selected topic 806's information.

The content panel 804 incorporates a prompt template 808 in line with the documentation content. This prompt template 808 is automatically generated based on the topic map associated with the currently displayed topic. The topic map, a structured representation of the topic's key concepts and related information, serves as the foundation for creating a relevant and context-aware prompt template.

The prompt template 808 is designed to be easily copied and pasted into the user's preferred generative AI agent interface. The prompt template 808 includes content item references that are specific references to relevant sections or pieces of information from the topic map. They provide the AI agent with contextual information directly related to the current topic. The prompt template 808 includes task instructions that are directions on what the AI should do with the provided information, guiding it to generate relevant and focused responses. The prompt template 808 includes constraint level instructions that are guidelines on how strictly the AI should adhere to the provided information, allowing for varying degrees of creativity or strictness in the generated response. Instead of a predefined query, the prompt template 808 includes a clearly marked placeholder (e.g., “[INSERT YOUR QUERY HERE]”). This allows users to easily replace it with their specific question or prompt about the topic.

The prompt template 808 is visually distinct within the content panel 804, highlighted or enclosed in a bordered section to draw user attention. It offers a “Copy to Clipboard” controls 808 for easy one-click copying of the entire template.

This GUI design integrates traditional documentation browsing with AI-assisted information retrieval. Users can explore the documentation conventionally through the TOC and content panels, while also having the option to formulate more complex queries or seek additional insights by using the provided prompt template with a generative AI agent. This approach enhances the user's ability to interact with and extract value from the documentation, combining the structure of traditional documentation with the flexibility and power of AI-assisted information retrieval.

### 6. Topic Maps with Content Item Summaries

In an embodiment, the topic maps 140 are structured to contain short summaries or descriptions of the content items 152 themselves rather than references to the content items 152. This approach is particularly useful in scenarios where the generative AI agent 160 is not configured to resolve or access external content item references directly. This design modification enhances the self-contained nature of the topic maps 140 and allows for more immediate use of the information by the AI agent 160.

In this embodiment, the topic forge 120 component of the multi-tenant provider network 100 is adapted to generate topic maps 140 with embedded content summaries. The process of creating these modified topic maps includes the topic forge 120 analyzing the target dataset(s) 150 to identify relevant topics and associated content items. Instead of simply storing references, the topic forge 120 employs NLP techniques to generate concise summaries of each relevant content item. This summarization can involve any of or a combination of extractive summarization techniques to select key sentences from the original content, abstractive summarization techniques using machine learning, such as sequence-to-sequence-based mode, a transformer-based model, a LLM fine-tuned for summarization tasks, or entity and key concept extraction to ensure salient information is captured in the summary.

In an embodiment, the topic forge 120 generates and includes information in the topic maps 140 in addition to the content item summaries, such as the original content's title, author, creation date, and a confidence score for the summary's accuracy. Additionally, or alternatively, topic structuring information is included that organizes the summaries within the topic map structure, associating the summaries with their relevant topics.

The topic vault 130 is adapted to store these enhanced topic maps that now contain both the topic information or references and the content summaries. This modification increases the storage requirements for the topic vault 130 but provides several advantages. Each topic map now contains actual content snippets, making it a more self-sufficient unit of information. The need for resolving external references is eliminated, potentially improving response times. The generative AI agent 160 can work directly with the provided summaries without needing to access or process external content. The topic scope AI agent 110's operation is also modified. When it receives a query and identifies relevant topic maps, it now has immediate access to content summaries. This allows it to construct more informative prompts for the generative AI agent 160.

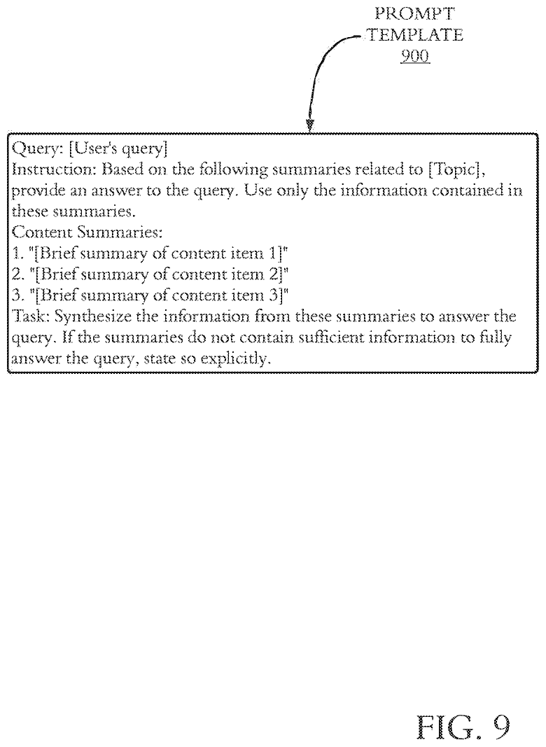

FIG. 9 illustrates an example prompt template 900 used by the topic scope AI agent 110 according to an embodiment of the present disclosure. In this example, before transmitting a prompt based on the prompt template 900 to the generative AI agent 160, the topic scope AI agent 110 would replace the “[User's query]” placeholder with an actual query, replace the “[Topic]” with a name of the current topic, and replace the “Brief summary of content item 1”, etc., with the actual generated summaries of content items for the current topic.

This approach offers several benefits. The generative AI agent 160 has immediate access to relevant information, improving its ability to provide accurate and contextual responses. Since the AI agent 160 is working from curated summaries, there is potentially greater consistency in responses across queries. Users can be more easily informed about the exact information sources used to generate responses.

### 7. Content Item Relevance Ranking/Scoring

In an embodiment, topic maps are enhanced with a ranking or scoring system for content item references or summaries, reflecting their relevance to the corresponding topic or the given query. This approach allows the generative AI agent 160 to prioritize the most pertinent information when formulating responses, potentially improving the accuracy and relevance of its outputs.

In an embodiment, the topic forge 120 is enhanced to include a relevance scoring algorithm. This algorithm employs one or more techniques, such as TF-IDF (Term Frequency-Inverse Document Frequency) scoring, to measure the importance of content items to a topic; semantic similarity measures using word embeddings or sentence transformers to calculate the closeness of content to the topic; or machine learning models trained on expert-labeled data to predict relevance scores. In an embodiment, for query-specific relevance, the topic scope AI agent 110 employs a real-time scoring system that evaluates content items against the current query.

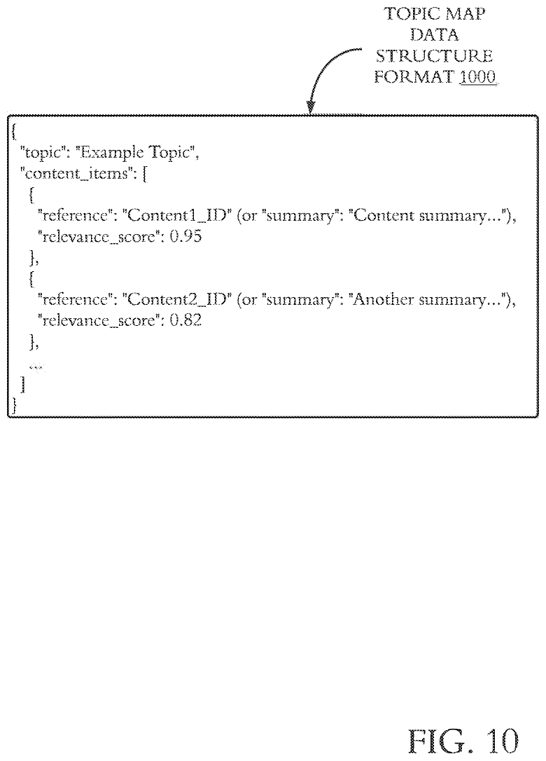

In an embodiment, the topic maps stored in the topic vault 130 are modified to include relevance scores for each content item reference or summary. FIG. 10 illustrates an example data structure format 1000 for representing topic maps in the topic vault, according to an embodiment of the present disclosure.

In an embodiment, the topic scope AI agent 110 implements a system to dynamically adjust relevance scores based on the specific query. This involves re-ranking content items based on their similarity to the query and combining pre-computed topic relevance with query-specific relevance.

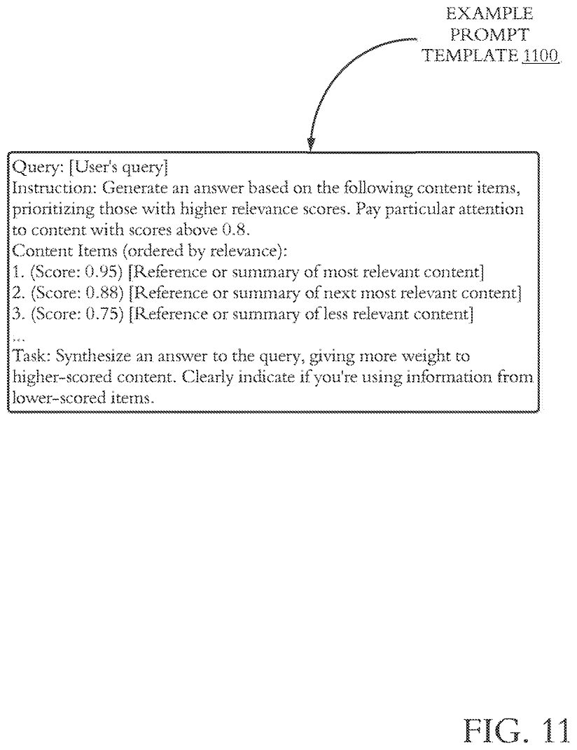

In an embodiment, when the topic scope AI agent 110 constructs the prompt for the generative AI agent 160, it incorporates the relevance information. FIG. 11 illustrates an example prompt template 1100 that provides a placeholder for an actual query and incorporates relevant information according to an embodiment of the present disclosure. In this example, the task instructions for the generative AI agent 160 command the AI agent 160 to pay particular attention to content items with a relevance score above a threshold (0.8 in this example) when generating the answer to the query.

The generative AI agent 160 is specifically instructed to consider the relevance scores when crafting its response. This involves any prioritizing information from higher-scored content items, using lower-scored items only for supplementary details or context, or potentially ignoring very low-scored items unless necessary.

In an embodiment, the generative AI agent 160 implements a weighted information synthesis approach. For example, information from content items with scores >0.9 might be considered crucial and always included, whereas content scored between 0.7-0.9 might be used for supporting details, and content below 0.7 might only be used if directly relevant to a specific part of the query not covered by higher-scored items.

In an embodiment, a feedback mechanism is implemented where the effectiveness of the relevance-based prioritization is evaluated based on user interactions or feedback. This data is used to refine the relevance scoring algorithm over time.

In an embodiment, the generative AI agent 160 is instructed to indicate the relevance scores of the information it uses in its response, providing transparency to the end-user about the source and perceived importance of different pieces of information.

The ranking-based approach offers several advantages. By prioritizing highly relevant content, the system can generate more focused and pertinent answers. The AI can quickly identify the most important information, potentially reducing processing time and improving response speed. The system can adapt to different queries by dynamically adjusting relevance based on the specific question asked. Users can understand the information that was considered most relevant to their query.

### 8. Extensions and Alternatives

In an embodiment, the topic scope AI agent 110 adopts a multi-step prompting strategy when interacting with the generative AI agent 160. Instead of sending the instructions and information in a single, comprehensive prompt, the agent 110 divides the communication into multiple, distinct prompts. This approach leverages the capability of many advanced language models to maintain context across multiple interactions, allowing for a more structured and potentially more effective use of the AI's capabilities.

In an embodiment, the topic scope AI agent 110 begins by sending a system prompt to the generative AI agent 160. This prompt sets the stage for the interaction and provides foundational information. It includes any of content item references or summaries from the relevant topic maps, general instructions on how to use this information, any constraints or guidelines for information usage, or metadata about the topics or content items such as relevance scores.

Following the system prompt, the topic scope AI agent 110 sends a user prompt. This prompt contains any of the specific query to be answered, any query-specific instructions or constraints, or guidance on how to format or structure the response.

In an embodiment, depending on the complexity of the query or the AI 160's initial response, the topic scope AI agent 110 sends additional prompts. These could include requests for clarification or expansion on specific points, instructions to consider additional perspectives or information, or guidance to refine or restructure the response.

In an embodiment, the architecture of the system is modified to accommodate a separation between the topic scope AI agent 110 and the generative AI agent 160. Instead of being part of the same provider network 100, the generative AI agent 160 is offered by a third-party service that the topic scope AI agent 110 integrates with. This arrangement allows for greater flexibility in leveraging specialized AI capabilities while maintaining the core functionality of the topic-scoped query processing system.

In this setup, the multi-tenant provider network 100 remains responsible for managing topic maps, processing queries, and orchestrating the overall workflow. However, when it comes to generating the final response, the topic scope AI agent 110 makes API calls to the external generative AI service.

In an embodiment, the topic scope AI agent 110 is adapted to operate on edge devices, such as end-users'computing devices, rather than solely within the centralized multi-tenant provider network 100. This approach brings the query processing and topic-scoped information retrieval closer to the user, offering advantages in terms of latency, privacy, and distributed computing capabilities.

### 9. Method for Input Normalization and Topic Map Generation Based on Tags

FIGS. 12A-12B describe a method for normalizing an input text from a user for topic map generation.

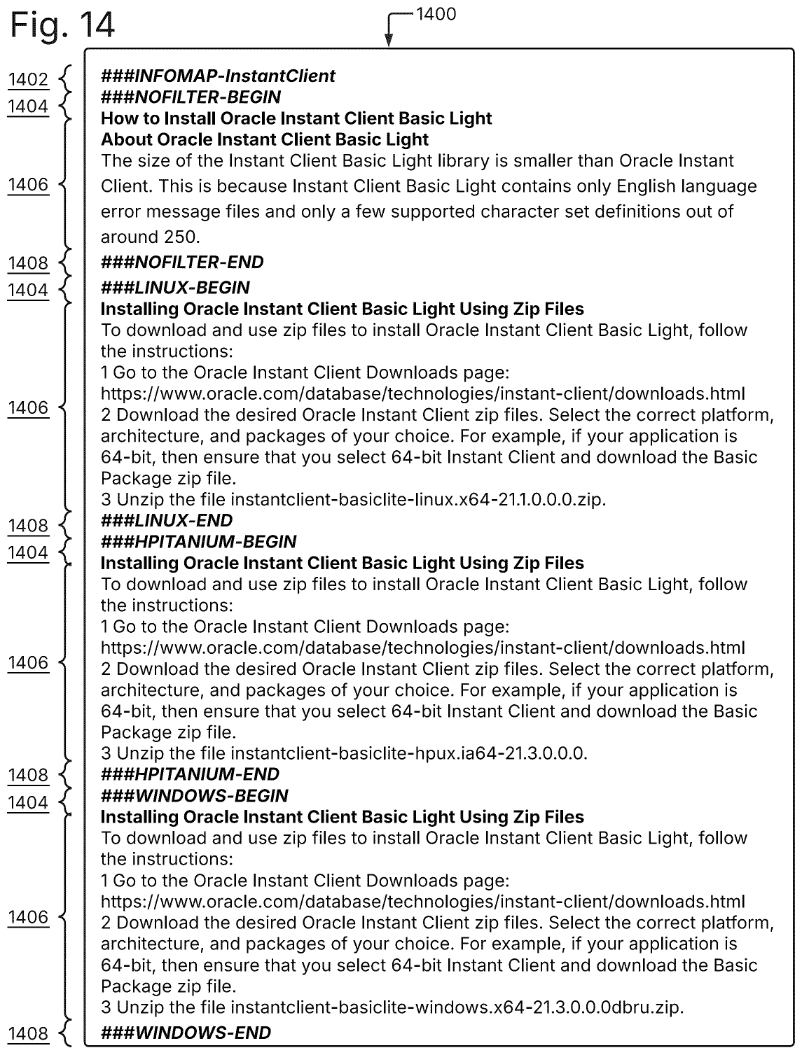

One or more embodiments receive raw text from a user (Operation 1202). The system provides the user with an interface for the user to provide raw text. An example of raw text is described below with respect to FIG. 14. Raw text refers to unprocessed, plain character data exactly as it was entered by the user with minimal formatting, markup, or structural metadata. The character data includes alphanumeric characters, punctuation marks, and control symbols. Notably, the raw text entry enables the user to input information directly without the overhead of formatting commands, graphical controls, or layout adjustments, thereby reducing the time required to record or transmit textual data. By capturing the essential character content, the system eliminates intermediate interactions, such as style selection, font manipulation, or visual confirmation of formatting, allowing the user to focus solely on conveying information. Additionally, the raw text includes alphanumeric tags that define the structure, organization, topics, names, features, or other substantive, semantic, or content attributes of the raw text.

One or more embodiments remove one or more identified formatting attributes in the raw text to generate a normalized input (Operation 1204). Although the raw text is generally free of formatting attributes, the user may utilize basic text formatting to develop and input the raw text in the text interface. The system strips metadata, markup, and presentation elements, such as font, color, alignment, or embedded style instructions, so the underlying sequence of characters remains. The resulting text contains no control codes or special rendering information, thereby representing a purely semantic data stream suitable for processing, indexing, or storage. Additionally, the system removes whitespace characters, such as spaces or tabs, from the raw text, forming a normalized input. The system converts multi-word sequences into a single uninterrupted character data string and may perform the conversion to selective portions of the raw text or comprehensively. Removing formatting attributes from stored text yields measurable space savings because formatting data accounts for a significant portion of a storage footprint. Rich-text formats, such as DOCX or HTML, embed style metadata, markup tags, and layout instructions alongside the text characters. When these non-essential elements are stripped, the resulting text contains the underlying alphanumeric content that is substantially smaller in size. This reduction in storage overhead improves transmission efficiency, reduces memory consumption, and allows larger text corpora to fit within the target dataset.

One or more embodiments identify a first tag and one or more second tags in the normalized input (Operation 1206). The first and second tags define article and page structures as well as additional filters of the normalized input, providing the system with context information for text corresponding to the tags. The first and second tags can be defined in the normalized input using alphanumeric markers, such as sequences of letters or numbers within the text, to demarcate the article and page structures. The alphanumeric markers act as delimiters or identifiers that are programmatically detected and parsed, allowing the system to isolate, extract, or interpret tagged portions of the text without relying on external formatting metadata. The alphanumeric markers can also take the form of enclosed marker patterns, for example, using square brackets. The system can scan the normalized input to locate the predefined marker patterns and isolate or associate the enclosed characters with a logical or semantic meaning.

One or more embodiments store the normalized input as content items based on the first tag and one or more second tags in one or more target datasets (Operation 1208). The structure of the target datasets and corresponding content items are described above with respect to FIG. 1. The normalized input, stored as content items in the target datasets, is associated with metadata for identifying, searching, and retrieving the normalized input by the system. Because the first and second tags provide relevant information regarding the contents of the normalized input, the system stores the normalized input, so categorization and retrieval are possible through direct reference to, at least, the first and second tags. If the first and second tags indicate a topic related to an existing content item in the target database, the system associates the normalized input with the existing content. Otherwise, if the system determines that the first and second tags indicate a new topic, the normalized input is stored based on information provided by the first and second tags. The system can store normalized input, including first and second tags, in a designated portion of the target dataset, such as a specific segment or partition categorized for such data. For example, the system may maintain separate logical or physical regions of the target dataset for different tag classes, so items sharing a common tag are co-located in a contiguous or indexed structure. As such, the system can locate and extract relevant data from the target datasets without additional computational overhead, reducing lookup time and resource consumption.

One or more embodiments parse the normalized input for a first tag and one or more second tags (Operation 1210). The normalized input is stored in the target dataset alongside a corpus of data and optionally in a separate region of the target dataset allocated to data with corresponding first and second tags. The system may constrain a retrieval scope of the desired normalized input to a known subset of such storage locations within the target dataset rather than scanning the entire dataset. The first tag may define the corresponding normalized input with a feature and assigned identifier. The first tag may also define the structure of an article within the normalized input. One or more second tags may be nested under a first tag to define a structure of one or more pages corresponding an article defined by the first tag.

One or more embodiments analyze the first tag and one or more second tags to identify one or more topics (Operation 1212). The first tag may correspond to one or more topics associated with the normalized input. For example, in the context of documentation related to artificial intelligence (AI), the first tag may include “vector embedding,” “hybrid vector indexes,” or “vector chains.” The second tag may correspond to a computing system associated with relevant portions of the normalized input. For example, the second tag may identify an operating system associated with text corresponding to the second tag, such as “Linux” or “Windows.” The second tag may also include content not associated with any operating system, tagged as, for example, “NOFILTER.” The second tag may also reference numerous additional filters associated with corresponding portions of the normalized input, such as a release version, depreciation version, platform type, product version, license information, or code language.

One or more embodiments generate a topic description based on the first tag, the one or more second tags, and content items relevant to the topic (Operation 1214). If the normalized data was stored based on reference to existing content items, the system extracts data associated with the existing content items and analyzes the aggregated data to identify recurring terms or contextual patterns. Using these extracted features, the system generates a synthesized topic description that reflects the substantive meaning represented by the extracted data. Additionally, or alternatively, the system evaluates relationships among content items with overlapping tags to refine the generated topic description. If the normalized data did not correspond to existing content items, the system can assign more weight to the first and second tags to determine the topic description. The system may determine contextual similarities between the first and second tags and other tags. Such recurring tags may be analyzed to determine the underlying common subject matter, and the system can generate a topic description that characterizes the core theme shared across the tagged data. Additionally, or alternatively, the system utilizes a combination of the above factors to determine the most relevant topic description.

One or more embodiments identify a set of references to the first tag, the one or more second tags, and content items relevant to the topic (Operation 1216). Similar to the process of generating a relevant topic description above, the system determines pointers or identifiers to the first tag, one or more second tags, and/or content items related to the normalized data. The system can determine the pointers or identifiers based on the frequency and/or distribution of the first and second tags and relevant content items. The system facilitates rapid navigation and retrieval of data associated with the pointers or identifiers. The pointers or identifiers may include positional data, index values, offsets within the target dataset, or cross-references linking the recurring tag to its corresponding text segment, enabling the system to efficiently locate, retrieve, or manipulate tagged content based on the topic description or a user query.

One or more embodiments create a topic map including the topic, the topic description, and the set of references (Operation 1218). This operation is performed as detailed in sections 3.2, 3.4, and 4.0 above and implemented in the same manner as described in the parent application.

### 10. Method for Topic Map Retrieval and HTML Generation Based on Tags

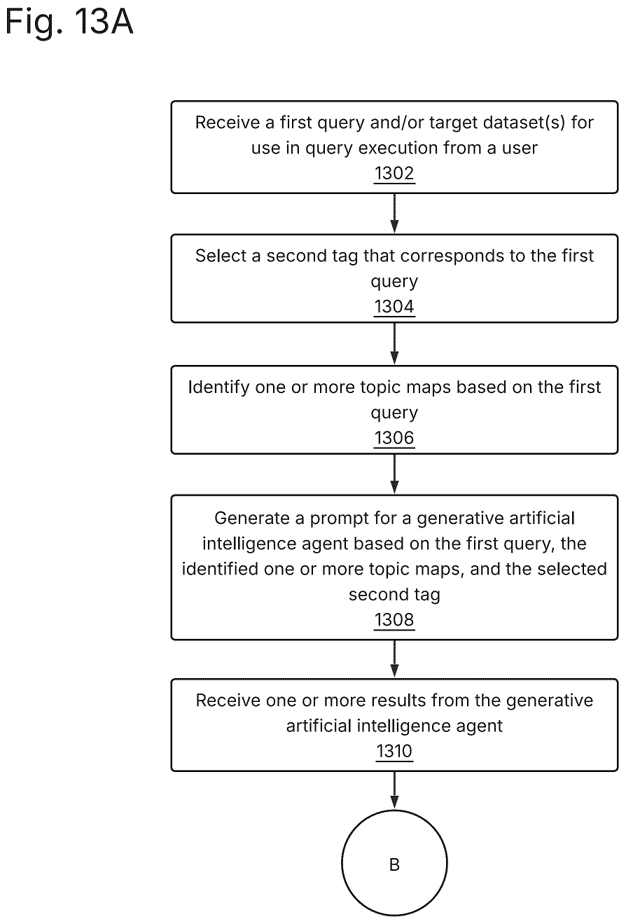

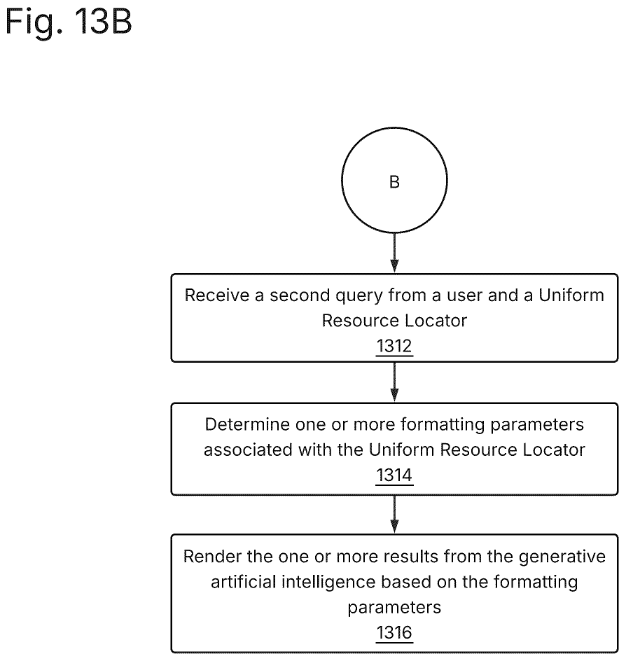

FIGS. 13A-13B describe a method for topic map retrieval and HTML generation based on tags.

One or more embodiments receive a first query and/or target dataset(s) for use in query execution from a user (Operation 1302). This operation is performed as detailed in operation 402A in sections 3.0 and 4.0 above and implemented in the same manner as described in the parent application.

One or more embodiments select a second tag that corresponds to the first query (Operation 1304). The system parses the first query to determine if it includes language that corresponds directly or indirectly to an existing second tag. For example, if the first query is “How do I install an instance client on Windows?”, the system will detect the term “Windows” in the first query and select the corresponding second tag. Additionally, or alternatively, the system can utilize a contextual similarity model to evaluate the proximity of terms within the first query to existing second tags and determine if any term is sufficiently close to an existing second tag based on a similarity score. In one or more embodiments, the listing of the one or more second tags is stored in a partition of the target dataset. The listing is referenced upon receiving the first query from the user to select the most relevant second tag. Furthermore, the system can update the listing based on new second tags detected in normalized input provided by the user.

One or more embodiments identify one or more topic maps based on the first query (Operation 1306). This operation is performed as detailed in operation 406A in sections 3.0 and 4.0 above and implemented in the same manner as described in the parent application.

One or more embodiments generate a prompt for a GenAI agent based on the first query, the identified one or more topic maps, and the selected second tag (Operation 1308). The normalized input from the user is stored in a contextualized manner as described in FIGS. 12A-12B above. Thus, retrieval of relevant information can be optimized through a prompt constrained to the user's first query, identified topic maps, and contextual weight given to the selected second tag. Additionally, or alternatively, the system may adapt or refine the prompt based on historical usage patterns, second tag recurrence frequency, or semantic similarity evaluations performed between the first query and previously processed queries. The system can dynamically augment the prompt with clarifying context derived from the second tag, enabling the GenAI agent to resolve ambiguous terminology and maintain topical coherence.

One or more embodiments receive one or more results from the GenAI agent (Operation 1310). This operation is performed as detailed in operation 410A in sections 3.0 and 4.0 above and implemented in the same manner as described in the parent application.

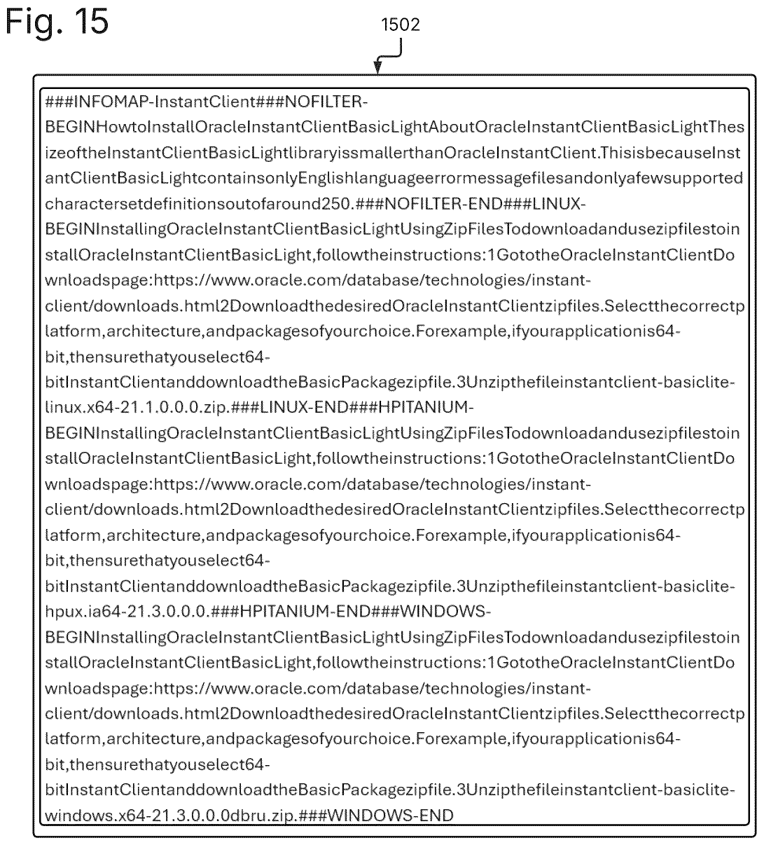

One or more embodiments receive a second query from a user and a Uniform Resource Locator (Operation 1312). The second query can instruct the system to render the one or more results from the GenAI agent in HTML based on one or more URLs. The system stores the normalized input without formatting or whitespace as described with respect to FIG. 15 below. Thus, generation of the one or more results by the GenAI agent will not have the requisite formatting to display the raw content in a readable fashion in HTML. Furthermore, the system receives a URL from the user or, alternatively, from a predefined list of URLs designated to provide formatting guidelines for the one or more results.

One or more embodiments determine one or more formatting parameters associated with the URL (Operation 1314). The system retrieves presentation characteristics from a webpage referenced by the URL and applies corresponding stylistic rules to the one or more results. The system parses the webpage to extract layout attributes, such as font families, heading hierarches, spacing patterns, color schemes, and structural relationships. The system generates a formatting profile that characterizes the visual style of the referenced page. Additionally, or alternatively, the system can analyze semantic cues present in the URL to infer presentation rules that govern the organization of material on the reference webpage.

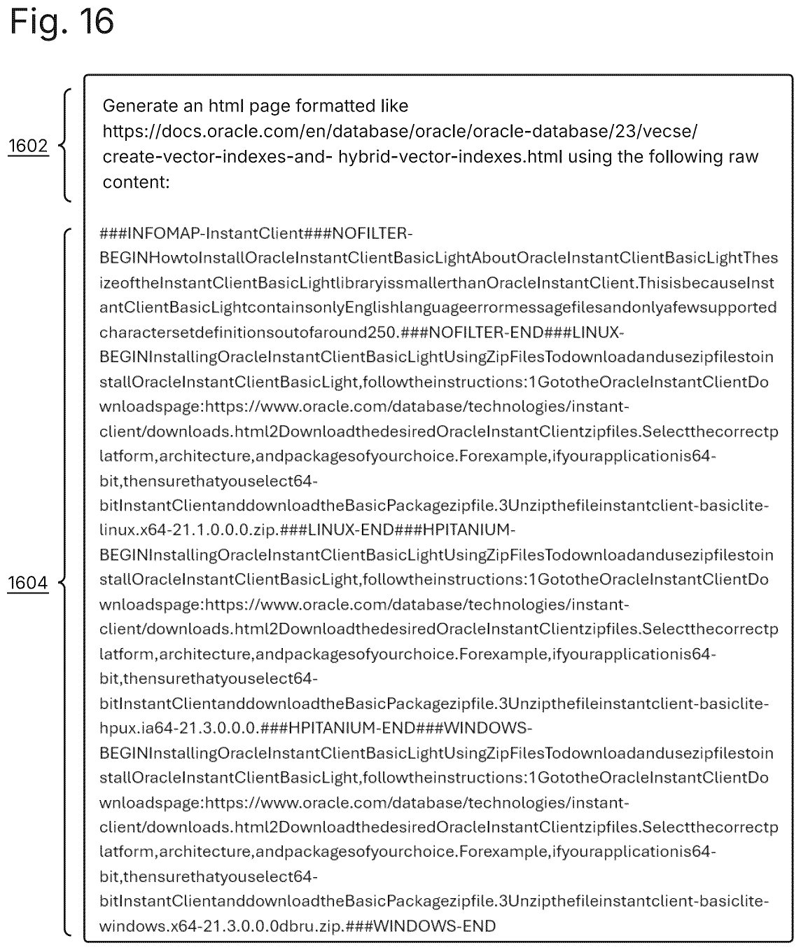

One or more embodiments render the one or more results from the GenAI based on the formatting parameters (Operation 1316). The system applies the generated formatting profile to the one or more results from the GenAI agent. The system can additionally map the inferred presentation rules onto the one or more results to generate headings, subheadings, paragraphs, spacing, or code blocks that exhibit stylistic similarity to the layout of the reference webpage. Thus, the system can generate an HTML webpage that visually resembles the webpage referenced by the URL. Additionally, or alternatively, the system can generate instructions that can subsequently be input to the GenAI agent, either manually or automatically, to generate the HTML webpage. An example of such instructions is described with respect to FIG. 16 below.

### 11. Raw Text Input and Retrieval Example

FIG. 14 illustrates an example of a raw text input provided by a user. This example details raw text of a documentation article for storage as a topic map and subsequent retrieval based on a query.

In one or more embodiments, interface 1400 for text entry may include a display region configured to present a text input field and one or more interactive elements for receiving user input. The interface can be implemented on various computing devices, such as smartphones, tablets, laptops, or desktop systems. A processor associated with the device detects input events from different systems, such as a touchscreen keyboard, hardware keyboard, stylus input, or voice transcription system, and converts those events into textual characters rendered within the input field. The exemplary text shown in interface 1400 depicts formatted text, including bolded and italicized text. The system permits the user to utilize formatting while inputting text for ease and comprehension of data entry. However, upon completion and entry of the text, the system will remove the formatting as described below with respect to FIG. 15.

In one or more embodiments, a subject tag 1402 (or article-level tag) represents a topic associated with the entire text input provided on interface 1400. In this example, the topic of the first tag is set as “Instant Client.” Furthermore, the first tag is preceded by the alphanumeric marker “###,” and a subsequent designation “INFOMAP” that indicates the designated topic of the tag. Thus, the alphanumeric marker designates the start of a tag, and the subsequent designation indicates the type of tag. When searching the dataset, the system locates this predefined marker and associates the subsequent text as the desired topic.

In one or more embodiments, the subject tags 1402 may include various types of markers, such as “###”, “;;;”, or “[TAG]”, to indicate the start of a tag. The designation following the marker can also vary, and may include terms such as “INFOMAP”, “TOPIC”, “ARTICLE”, or other custom designations that indicate the topic of the tag. For example, the subject tag 1402 could be preceded by “###” and followed by “ARTICLE: Instant Client”, or preceded by “[TAG]” and followed by “TOPIC: Instant Client”. The system can be configured to recognize and parse different marker and designation combinations, allowing for flexibility in how users input tags.

In one or more embodiments, a begin tag (or page-level tag) 1404 follows the subject tag 1402. The second tag includes a similar alphanumeric marker “###” followed by “NOFILTER-BEGIN.” This designation indicates that the begin tag 1404 corresponds to a page-level description nested within the subject tag 1402 and marks the beginning of the description. The designation “NOFILTER” indicates that the description is not associated with any particular operating system.

In one or more embodiments, the begin tag 1404 can include various designations to indicate the type of page-level description. For example, instead of “NOFILTER-BEGIN”, the designation could be “OS-BEGIN”, “PLATFORM-START”, or “SECTION-INIT”. The system can be configured to recognize and parse different designation patterns, allowing users to customize the tagging structure to suit their needs. Additionally, the begin tag 1404 can be preceded by different markers, such as “;;;”, “[PAGE]”, or “<BEGIN>”, to provide further flexibility in the tagging system.

In one or more embodiments, text block 1406 is text that corresponds to the “NOFILTER” page-level description. Notably, the text is input without additional reference to any source material. As described with respect to FIGS. 12A-12B above, the system stores the raw data (after normalization) in the target dataset based on relevancy associations with other tags and/or content items. Thus, text block 1406 is stored and linked to content items in the dataset with substantive similarity. The subject tag 1402 and the begin tag 1404 are additionally, or alternatively, utilized to determine the relevancy associations.

In one or more embodiments, text blocks 1406 can be associated with other types of content items in the dataset, such as images, videos, or code snippets. The system can use the subject tags and the begin tags to determine the relevancy associations between the text block 1406 and other content items, such as diagrams illustrating the installation process or code examples that demonstrate the usage of the instant client. The system can also use machine learning algorithms to identify semantic relationships between the text block 1406 and other content items, allowing for more accurate and relevant associations.

In one or more embodiments, an end tag 1408 marks the end of the begin tag 1404 and delimits the text block 1406. The end tag 1408 marks the end of the “NOFILTER” section under subject tag 1402. Specifically, text within the text block 1406 between the begin tag 1404 and the end tag 1408 is associated with the “NOFILTER” portion of the “Instant Client” documentation article.

In one or more embodiments, the end tags 1408 can be used in conjunction with other tags to define more complex structures, such as nested sections or conditional content. For example, an end tag 1408 may be followed by a conditional tag that indicates the end of a specific section only if a certain condition is met. The system can use the end tags 1408 and other tags to create a hierarchical structure that allows for more precise control over the content and its presentation.

Under the “NOFILTER” section, FIG. 14 depicts three more page-level tag sections; the sections include a respective begin tag 1404, text block 1406, and end tag 1408. The three page-level tag sections describe, through the respective begin tag 1404 and end tag 1408, “LINUX,” “HPITANIUM,” and “WINDOWS” operating systems. Thus, the text blocks 1406 within the sections will be attributed to the respective operating systems within the “Instant Client” documentation article and associated, in the dataset, with similar tags and/or content items. The specific, tiered indexing of text blocks 1406 enables rapid retrieval operations, irrespective of the overall size of the text corpus in the target dataset.

For example, a documentation specialist tasked with generating technical documentation with instructions on how to install an Oracle Instant Client. The installation instructions include steps that vary based on a target operating system and a user accessing the technical documentation will generally reference instructions corresponding to the target operating system. Utilizing the features illustrated in FIGS. 12A-12B, the documentation specialist can input raw text with minimal formatting, as shown in the interface 1400. Rather than being written for publication, the documentation can be written for storage in a target dataset and subsequent reference and/or retrieval upon request from a user. As such, the technical documentation generated by the documentation specialist need not conform to stylistic, formatting, or narrative conventions required for published documentation. Instead, the technical documentation may be optimized for rapid creation, minimal structure, and efficient storage.

The documentation specialist can utilize the subject tag 1402 to delineate the general topic of the technical documentation, utilizing desired combinations of markers and designations for accurate system interpretation and storage of the technical documentation. The documentation specialist can further utilize the begin tag 1404 and end tag 1408 to mark the boundaries of the text block 1406. The begin tag 1404 and end tag 1408 include their own markers and designations that are customizable based on documentation input requirements. As such, to input installation instructions for different operation systems, the documentation specialist can draft text blocks 1406 marked with the begin tag 1404 and the end tag 1408. The documentation specialist can utilize minimal formatting in the raw text for ease and clarity of input. Each subsequent section corresponding to a new operating system can be appended to the previous section, as depicted in FIG. 14.

Upon completing input of the raw text of the installation instructions in the interface 1400, the documentation specialist can submit the instructions for classification and filing in a target dataset based on, at least, the subject tag 1402, begin tag 1404, and end tag 1408. Prior to storage in the target database, the system will detect and remove all formatting from the raw text, including whitespace characters, to generate normalized text. FIG. 15 illustrates an example of normalized text generated from the raw text shown in FIG. 14. Specifically, block 1502 depicts normalized text with formatting and whitespace removed. The normalized text is then stored in the target dataset and, subsequently, processed into a topic map as described with respect to FIG. 1 above.

Subsequently, if a user requires specific installation instructions, the user can query a GenAI agent to access the dataset for relevant information. For example, the user's query can read “provide installation instructions for an Oracle Instant Client on Windows.” From the user's query, the system can parse “instant client”, “installation instructions”, and “Windows”. The system determines relevant portions of the target database, including tags stored in a mapping registry and/or topic maps that correspond to the parsed information. Based on the relevant portions in the target database, the system can extract and present an answer to the user's query. Alternatively, if the user wishes to see the answer published in documentation format, the system provides a prompt that, when input to a GenAI agent, displays the answer formatted in the documentation format. FIG. 16 illustrates an example of HTML generation text that can be input to a GenAI agent. Instructions 1602 provide the reference URL, and the system extracts formatting parameters from the reference URL. Furthermore, the instructions 1602 indicate that the text following the instructions is raw content. The raw content 1604 is an example of the one or more results from the GenAI agent described in FIGS. 13A-13B above. As such, the raw content 1604 does not include any formatting or whitespace.

### 12. Machine Learning Architecture

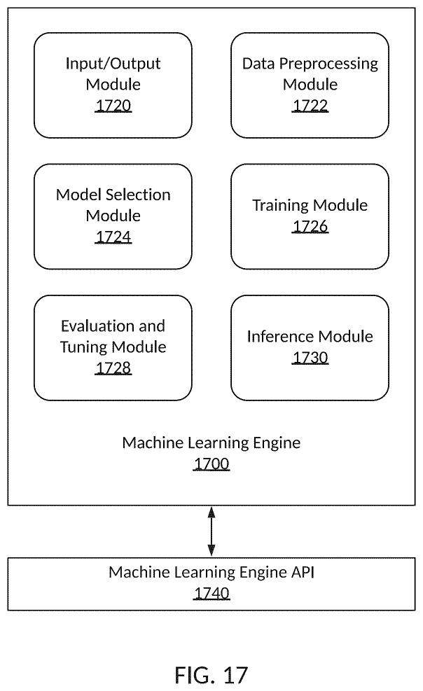

FIG. 17 illustrates a machine learning engine 1700 in accordance with one or more embodiments. As illustrated in FIG. 17, machine learning engine 1700 includes input/output module 1720, data preprocessing module 1722, model selection module 1724, training module 1726, evaluation and tuning module 1728, and inference module 1730.

In accordance with an embodiment, input/output module 1720 serves as the primary interface for data entering and exiting the system, managing the flow and integrity of data. This module may accommodate a wide range of data sources and formats to facilitate integration and communication within the machine learning architecture.

In an embodiment, an input handler within input/output module 1720 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 1720 to be versatile in different operational contexts, whether processing historical datasets or streaming data.

In accordance with an embodiment, input/output module 1720 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 1720 includes an output framework designed to handle the distribution and exportation of outputs, predictions, or insights. Using the output framework, input/output module 1720 formats these outputs into user-friendly and accessible formats, such as reports, visualizations, or data files compatible with other systems. Input/output module 1720 also ensures secure and efficient transmission of these outputs to end-users or other systems in an embodiment and may employ encryption and secure data transfer protocols to maintain data confidentiality.

In accordance with an embodiment, data preprocessing module 1722 transforms data into a format suitable for use by other modules in machine learning engine 1700. For example, data preprocessing module 1722 may transform raw data into a normalized or standardized format suitable for training ML models and for processing new data inputs for inference. In an embodiment, data preprocessing module 1722 acts as a bridge between the raw data sources and the analytical capabilities of machine learning engine 1700.

In an embodiment, data preprocessing module 1722 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 1722 may be configured to handle anomalies in different ways depending on context. Data preprocessing module 1722 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 1722 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 1722 processes new data for inference, data preprocessing module 1722 replicates the same preprocessing steps to ensure consistency with the training data format. This helps to avoid discrepancies between the training data format and the inference data format, thereby reducing the likelihood of inaccurate or invalid model predictions.

In an embodiment, model selection module 1724 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 1724 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 1724 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 1724 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 1724 also considers computational efficiency and resource constraints. This is meant to help ensure the selected model is both accurate and practical in terms of computational and time requirements. In an embodiment, certain features of model selection module 1724 are configurable such as a configured bias toward (or against) computational efficiency.

In accordance with an embodiment, training module 1726 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 1726 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 1726 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 1726 includes logic to handle different types of data and learning tasks. For instance, it includes different training routines for supervised learning (where the training data comes with labels) and unsupervised learning (without labeled data). In the case of deep learning models, training module 1726 also manages the complexities of training neural networks that include initializing network weights, choosing activation functions, and setting up neural network layers.

In an embodiment, evaluation and tuning module 1728 incorporates dynamic feedback mechanisms and facilitates continuous model evolution to help ensure the system's relevance and accuracy as the data landscape changes. Evaluation and tuning module 1728 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 1728 performs continuous model tuning by using hyperparameter optimization. Evaluation and tuning module 1728 performs an exploration of the hyperparameter space using algorithms, such as grid search, random search, or more sophisticated methods like Bayesian optimization. Evaluation and tuning module 1728 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 1728 integrates data feedback and updates the model. Evaluation and tuning module 1728 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 1728 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 1728 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 1730 transforms data raw data into actionable, precise, and contextually relevant predictions. In addition to processing and applying a trained model to new data, inference module 1730 may also include post-processing logic that refines the raw outputs of the model into meaningful insights.

In an embodiment, inference module 1730 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 1730 transforms the outputs of a trained model into definitive classifications. Inference module 1730 employs the underlying model as a tool to generate probabilistic outputs for each potential class. It then engages in an interpretative process to convert these probabilities into concrete class labels.

In an embodiment, when inference module 1730 receives the probabilistic outputs from the model, it analyzes these probabilities to determine how they are distributed across some or every potential class. If the highest probability is not significantly greater than the others, inference module 1730 may determine that there is ambiguity or interpret this as a lack of confidence displayed by the model.

In an embodiment, inference module 1730 uses thresholding techniques for applications where making a definitive decision based on the highest probability might not suffice due to the critical nature of the decision. In such cases, inference module 1730 assesses if the highest probability surpasses a certain confidence threshold that is predetermined based on the specific requirements of the application. If the probabilities do not meet this threshold, inference module 1730 may flag the result as uncertain or defer the decision to a human expert. Inference module 1730 dynamically adjusts the decision thresholds based on the sensitivity and specificity requirements of the application, subject to calibration for balancing the trade-offs between false positives and false negatives.

In accordance with an embodiment, inference module 1730 contextualizes the probability distribution against the backdrop of the specific application. This involves a comparative analysis, especially in instances where multiple classes have similar probability scores, to deduce the most plausible classification. In an embodiment, inference module 1730 may incorporate additional decision-making rules or contextual information to guide this analysis, ensuring that the classification aligns with the practical and contextual nuances of the application.

In regression models, where the outputs are continuous values, inference module 1730 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 1730 incorporates domain-specific adjustments into its post-processing routine. This involves tailoring the model's output to align with specific industry knowledge or contextual information. For example, in financial forecasting, inference module 1730 may adjust predictions based on current market trends, economic indicators, or recent significant events, ensuring that the outputs are both statistically accurate and practically relevant.

In an embodiment, inference module 1730 includes logic to handle uncertainty and ambiguity in the model's predictions. In cases where inference module 1730 outputs a measure of uncertainty, such as in Bayesian inference models, inference module 1730 interprets these uncertainty measures by converting probabilistic distributions or confidence intervals into a format that can be easily understood and acted upon. This provides users with both a prediction and an insight into the confidence level of that prediction. In an embodiment, inference module 1730 includes mechanisms for involving human oversight or integrating the instance into a feedback loop for subsequent analysis and model refinement.

In an embodiment, inference module 1730 formats the final predictions for end-user consumption. Predictions are converted into visualizations, user-friendly reports, or interactive interfaces. In some systems, like recommendation engines, inference module 1730 also integrates feedback mechanisms, where user responses to the predictions are used to continually refine and improve the model, creating a dynamic, self-improving system.

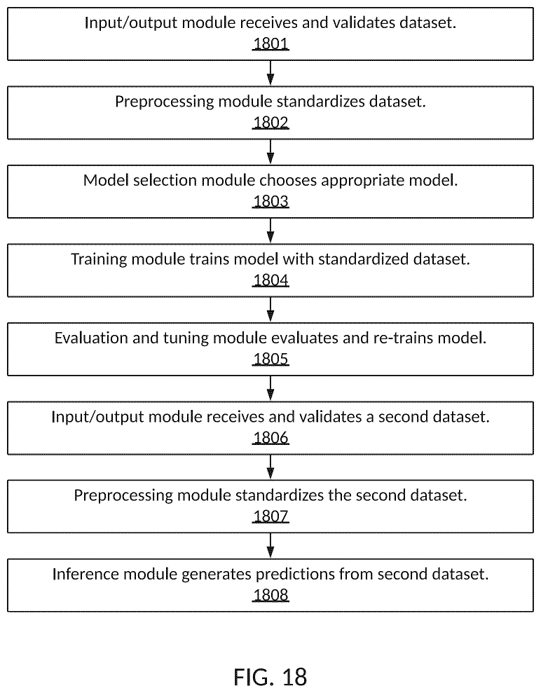

FIG. 18 illustrates the operation of a machine learning engine in one or more embodiments. In an embodiment, input/output module 1720 receives a dataset intended for training (Operation 1801). This data can originate from diverse sources, like databases or real-time data streams, and in varied formats, such as CSV, JSON, or XML. Input/output module 1720 assesses and validates the data, ensuring its integrity by checking for consistency, data ranges, and types.

In an embodiment, training data is passed to data preprocessing module 1722. Here, the data undergoes a series of transformations to standardize and clean it, making it suitable for training ML models (Operation 1802). This involves normalizing numerical data, encoding categorical variables, and handling missing values through techniques like imputation.

In an embodiment, prepared data from the data preprocessing module 1722 is then fed into model selection module 1724 (Operation 1803). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 1726 trains the selected model with the prepared dataset (Operation 1804). It implements learning algorithms to adjust the model's internal parameters, optimizing them to identify patterns and relationships in the training data. Training module 1726 also addresses the challenge of overfitting by implementing techniques, like regularization and early stopping, ensuring the model's generalizability.

In an embodiment, evaluation and tuning module 1728 evaluates the trained model's performance using the validation dataset (Operation 1805). Evaluation and tuning module 1728 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 1720 receives a dataset intended for inference. Input/output module 1720 assesses and validates the data (Operation 1806).

In an embodiment, data preprocessing module 1722 receives the validated dataset intended for inference (Operation 1807). Data preprocessing module 1722 ensures that the data format used in training is replicated for the new inference data, maintaining consistency and accuracy for the model's predictions.

In an embodiment, inference module 1730 processes the new data set intended for inference, using the trained and tuned model (Operation 1808). It applies the model to this data, generating raw probabilistic outputs for predictions. Inference module 1730 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 1740 allows for applications to leverage machine learning engine 1700. In an embodiment, machine learning engine API 1740 may be built on a RESTful architecture and offer stateless interactions over standard HTTP/HTTPS protocols. Machine learning engine API 1740 may feature a variety of endpoints, each tailored to a specific function within machine learning engine 1700. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 1740 is equipped to support SOAP-based interactions. This extension involves defining a WSDL (Web Services Description Language) document that outlines the API's operations and the structure of request and response messages. In an embodiment, machine learning engine API 1740 supports various data formats and communication styles. In an embodiment, machine learning engine API 1740 endpoints may handle requests in JSON format or any other suitable format. For example, machine learning engine API 1740 may process XML, and it may also be engineered to handle more compact and efficient data formats, such as Protocol Buffers or Avro, for use in bandwidth-limited scenarios.

In an embodiment, machine learning engine API 1740 is designed to integrate WebSocket technology for applications necessitating real-time data processing and immediate feedback. This integration enables a continuous, bi-directional communication channel for a dynamic and interactive data exchange between the application and machine learning engine 1700.

### 13. Generative Models

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a SoftMax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 1720, when used for large language models, handles textual data, converting input text into a format that the model can process. This typically involves tokenization, where the text is broken down into manageable pieces, such as words or sub words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 1722 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 1724, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 1726, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs (Graphics Processing Units) or TPUs (Tensor Processing Units) to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 1728 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 1730, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

The self-attention mechanism, which is part of a transformer network, enables the model to weigh the importance of different elements within an input sequence, regardless of their position. This allows the model to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 14. Practical Applications, Advantages, and Improvements

Embodiments provide several practical applications, advantages, and improvements over existing content input and analysis systems. These advantages and improvements include the following:

Enhanced precision: Embodiments improve the precision of responses provided by a GenAI agent by detailed categorization of input data within a target dataset. For example, the utilization of input tags in tandem with topic map generation increases the precision of the generative artificial intelligence agent.

Increased efficiency: Embodiments provide for the efficient storage of input data through pre-processing, formatting reduction, and accurate categorization using input tags. Embodiments further provide for efficient data input by leveraging topic map generation with input contextualization.

Enhanced speed of data retrieval: Embodiments provide for enhanced speed of data retrieval through tag-based categorization, analysis, and storage of input data.

Reduced hallucinations: Embodiments provide for a reduction in the hallucinations produced by GenAI by augmenting the retrieval of data through a tiered data classification system using input tags in tandem with topic map generation.

### 15. Terminology

As used herein and in the appended claims, the term “computer-readable media” refers to one or more mediums or devices that store or transmit information in a format that a computer system accesses. Computer-readable media encompasses both storage media and transmission media. Storage media includes volatile and non-volatile memory devices such as RAM devices, ROM devices, secondary storage devices, register memory devices, memory controller devices, graphics memory devices, and the like. Transmission media includes wired and wireless physical pathways that carry communication signals such as twisted pair cable, coaxial cable, fiber optic cable, radio waves, microwaves, infrared, visible light communication, and the like.

As used herein and in the appended claims, the term “non-transitory computer-readable media” encompasses computer-readable media as just defined but excludes transitory, propagating signals. Data stored on non-transitory computer-readable media is not just momentarily present and fleeting but has some degree of persistence. For example, instructions stored in a hard drive, an SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices can be the same or different devices.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, unless otherwise clear in context, phrases such as “a device configured to” are intended to include one or more recited devices. Such one or more recited devices, unless otherwise clear in context, are collectively configured to carry out the stated recitations. For example, “a processor configured to carry out recitations A, B and C” encompasses both (a) a single processor configured to carry out recitations A, B, and C and (b) a first processor configured to carry out recitation A working in conjunction with a second processor configured to carry out recitations B and C.

Unless otherwise clear in context, the terms “set,” and “collection” should generally be interpreted to include one or more described items throughout this application. Accordingly, unless otherwise clear in context, phrases such as “a set of devices configured to” or “a collection of devices configured to” are intended to include one or more recited devices. Such one or more recited devices, unless otherwise clear in context, are collectively configured to carry out the stated recitations. For example, “a set of servers configured to carry out recitations A, B and C” encompasses both (a) a single server configured to carry out recitations A, B, and C and (b) a first server configured to carry out recitations A and B working in conjunction with a second server configured to carry out recitation C.

As used herein, unless otherwise clear in context, the term “or” is open-ended and encompasses all possible combinations, except where infeasible. For example, if it is stated that a component includes A or B, then, unless infeasible or otherwise clear in context, the component includes at least A, or at least B, or at least A and B. As a second example, if it is stated that a component includes A, B, or C then, unless infeasible or otherwise clear in context, the component includes at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. is either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” or “responsive to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

In the foregoing specification, one or more embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
receiving raw text from a user; wherein the raw text comprises a first tag and one or more second tags;
identifying one or more formatting attributes in the raw text;
removing the one or more formatting attributes, comprising one or more whitespace characters, to generate a normalized input;
storing the normalized input in one or more target datasets; and
generating one or more topic maps for the one or more target datasets based on the first tag and the one or more second tags; wherein the one or more topic maps comprise one or more references to content items within the one or more target datasets.

2. The one or more non-transitory computer-readable media of claim 1, wherein the generating the one or more topic maps comprises:
parsing the normalized input for the first tag and the one or more second tags; wherein the first tag corresponds to one or more topics and the one or more second tags represent a computing system associated with corresponding portions of the normalized input;
analyzing the first tag and the one or more second tags to identify the one or more topics; and
for each topic of the one or more topics:
generating a topic description based on the first tag, the one or more second tags, and the content items in the one or more target datasets that are relevant to the topic;
identifying a set of references to the first tag, the one or more second tags, and the content items in the set of one or more target datasets that are relevant to the topic; and
creating the topic map comprising the topic, the topic description, and the set of references;
wherein the one or more topic maps comprise the topic maps generated for the one or more topics.

3. The one or more non-transitory computer-readable media of claim 1, further comprising:
receiving a first query;
selecting a second tag, from the one or more second tags, that corresponds to the first query;
identifying a subset of the one or more topic maps corresponding to the first query and the second tag;
generating a prompt for a generative artificial intelligence agent comprising a language model based on the first query, the identified subset of the one or more topic maps, and the selected second tag;
transmitting the prompt to the generative artificial intelligence agent;
receiving one or more results from the generative artificial intelligence agent; and
storing the one or more results for the first query.

4. The one or more non-transitory computer-readable media of claim 3, wherein the identifying a subset of the one or more topic maps comprises:
generating a vector representation of the first query;
comparing the vector representation of the first query to one or more respective vector representations of the topic maps; and
selecting a subset of one or more topic maps based on one or more similarity measures for the vector representation of the first query and the one or more respective vector representations of the topic maps.

5. The one or more non-transitory computer-readable media of claim 3, wherein the selecting the second tag that corresponds to the first query comprises:
parsing the first query to identify one or more references to a computing system named or described in the first query;
determining a second tag, from the one or more second tags, that matches the identified computing system; and
selecting the determined second tag as the second tag that corresponds to the first query.

6. The one or more non-transitory computer-readable media of claim 3, wherein the operations further comprise:
receiving a second query; and
presenting, in response to receiving the second query, the one or more results on a display.

7. The one or more non-transitory computer-readable media of claim 6, wherein the presenting the one or more results on a display comprises:
formatting the one or more results from the generative artificial intelligence agent into a hypertext markup language.

8. The one or more non-transitory computer-readable media of claim 7, wherein the formatting the one or more results comprises:
receiving a uniform resource locator;
determining one or more formatting parameters associated with the uniform resource locator; and
rendering the one or more results based on the formatting parameters.

9. A method comprising:
receiving raw text from a user; wherein the raw text comprises a first tag and one or more second tags;
identifying one or more formatting attributes in the raw text;
removing the one or more formatting attributes, comprising one or more whitespace characters, to generate a normalized input;
storing the normalized input in one or more target datasets; and
generating one or more topic maps for the one or more target datasets based on the first tag and the one or more second tags; wherein the one or more topic maps comprise one or more references to content items within the one or more target datasets;
wherein the method is performed by at least one device including a hardware processor.

10. The method of claim 9, wherein the generating the one or more topic maps comprises:
parsing the normalized input for the first tag and the one or more second tags; wherein the first tag corresponds to one or more topics and the one or more second tags represent a computing system associated with corresponding portions of the normalized input;
analyzing the first tag and the one or more second tags to identify the one or more topics; and
for each topic of the one or more topics:
generating a topic description based on the first tag, the one or more second tags, and the content items in the one or more target datasets that are relevant to the topic;
identifying a set of references to the first tag, the one or more second tags, and the content items in the set of one or more target datasets that are relevant to the topic; and
creating the topic map comprising the topic, the topic description, and the set of references; and
wherein the one or more topic maps comprise the topic maps generated for the one or more topics.

11. The method of claim 9, further comprising:
receiving a first query;
selecting a second tag, from the one or more second tags, that corresponds to the first query;
identifying a subset of the one or more topic maps corresponding to the first query and the second tag;
generating a prompt for a generative artificial intelligence agent comprising a language model based on the first query, the identified subset of the one or more topic maps, and the selected second tag;
transmitting the prompt to the generative artificial intelligence agent;
receiving one or more results from the generative artificial intelligence agent; and
storing the one or more results for the first query.

12. The method of claim 11, wherein the identifying a subset of the one or more topic maps comprises:
generating a vector representation of the first query;
comparing the vector representation of the first query to one or more respective vector representations of the topic maps; and
selecting a subset of one or more topic maps based on one or more similarity measures for the vector representation of the first query and the one or more respective vector representations of the topic maps.

13. The method of claim 11, wherein the selecting the second tag that corresponds to the first query comprises:
parsing the first query to identify one or more references to a computing system named or described in the first query;
determining a second tag, from the one or more second tags, that matches the identified computing system; and
selecting the determined second tag as the second tag that corresponds to the first query.

14. The method of claim 11, wherein the method further comprises:
receiving a second query; and
presenting, in response to receiving the second query, the one or more results on a display.

15. The method of claim 14, wherein the presenting the one or more results on a display comprises:
formatting the one or more results from the generative artificial intelligence agent into a hypertext markup language.

16. The method of claim 15, wherein the formatting the one or more results comprises:
receiving a uniform resource locator;
determining one or more formatting parameters associated with the uniform resource locator; and
rendering the one or more results based on the formatting parameters.

17. A system comprising:
one or more hardware processors;
one or more non-transitory computer-readable media; and
program instructions stored on the one or more non-transitory computer-readable media that, when executed by the one or more hardware processors, cause the system to perform operations comprising:
receiving raw text from a user; wherein the raw text comprises a first tag and one or more second tags;
identifying one or more formatting attributes in the raw text;
removing the one or more formatting attributes, comprising one or more whitespace characters, to generate a normalized input;
storing the normalized input in one or more target datasets; and
generating one or more topic maps for the one or more target datasets based on the first tag and the one or more second tags; wherein the one or more topic maps comprise one or more references to content items within the one or more target datasets;
parsing the normalized input for the first tag and the one or more second tags; wherein the first tag corresponds to one or more topics and the one or more second tags represent a computing system associated with corresponding portions of the normalized input;
analyzing the first tag and the one or more second tags to identify the one or more topics; and
for each topic of the one or more topics:
generating a topic description based on the first tag, the one or more second tags, and the content items in the one or more target datasets that are relevant to the topic;
identifying a set of references to the first tag, the one or more second tags, and the content items in the set of one or more target datasets that are relevant to the topic; and
creating the topic map comprising the topic, the topic description, and the set of references;
wherein the one or more topic maps comprise the topic maps generated for the one or more topics;
receiving a first query;
selecting a second tag, from the one or more second tags, that corresponds to the first query;
identifying a subset of the one or more topic maps corresponding to the first query and the second tag;
generating a prompt for a generative artificial intelligence agent comprising a language model based on the first query, the identified subset of the one or more topic maps, and the selected second tag;
transmitting the prompt to the generative artificial intelligence agent;
receiving one or more results from the generative artificial intelligence agent;
storing the one or more results for the first query.
